(19) United States
(12) Patent Application Publication
(10) Pub. No.: US 2024/0231296 A1
(43) Pub. Date: Jul. 11, 2024

(54) CONTROL METHOD, INFORMATION PROCESSING APPARATUS, AND NON-TRANSITORY COMPUTER READABLE STORAGE MEDIUM

(71) Applicant: Panasonic Intellectual Property Corporation of America, Torrance, CA (US)

(72) Inventors: Yumiko SHINOHARA, Kyoto (JP); Ryota FUJIMURA, Kanagawa (JP); Noriaki HORII, Kyoto (JP)

(73) Assignee: Panasonic Intellectual Property Corporation of America, Torrance, CA (US)

(21) Appl. No.: 18/615,052

(22) Filed: Mar. 25, 2024

Related U.S. Application Data
(63) Continuation of application No. PCT/JP2022/024598, filed on Jun. 20, 2022.

(30) Foreign Application Priority Data
Sep. 29, 2021 (JP) 2021-159911

(51) Int. Cl. G05B 15/02

(52) U.S. Cl. CPC G05B 15/02

(57) ABSTRACT

A control method by an information processing apparatus includes: acquiring operation information on a group of operations continuously performed to a plurality of devices disposed in a facility; calculating an operation cost required to perform the group of operations indicated by the operation information; generating, in a case that the operation cost is larger than a predetermined value, suggestion information indicative of a suggestion for performing collective control of the group of operations indicated by the operation information to the devices; and outputting the suggestion information.

### FIELD OF INVENTION

The present disclosure relates to a technique of suggesting collective control of devices.

### BACKGROUND ART

Patent Literature 1 discloses calculation of a displaying priority based on a distance between a home appliance and a home appliance control device, or on a priority dependent on each operation command acquired from the home appliance; and discloses that this calculation results in providing a user with an interface having an efficient array that allows more comfortable operation of a home appliance.

Patent Literature 2 suggests provision of an electric power management advising device and an electric power management method for presenting advice related to electric power saving to a user while causing no inconvenience to the user when a device is actually controlled in accordance with the advice. Specifically, it discloses that an advice outputting section is caused to output advice related to electric power saving generated by an advice generating section, and a collective control executing section collectively controls a plurality of devices based on the advice.

Patent Literature 1 discloses an interface for individually controlling a plurality of devices. However, since demand for IoT devices has been increasing, a capability of collectively controlling a plurality of devices makes it possible to live a more comfortable life. Patent Literature 2 discloses a device for suggesting collective control of a plurality of devices on the basis of advice related to electric power saving. However, Patent Literature 2 provides no consideration to collective control of a plurality of devices for a purpose other than the electric power saving.

A user required to operate respective switches proper to devices in order to control the devices may feel it inconvenient to individually operate the respective switches proper to the devices. Therefore, in suggesting collective control of a plurality of devices, it is required to obviate the inconvenience that the user feels in operations to the devices.

Patent Literature 1: Japanese Patent No. 5081093

Patent Literature 2: Japanese Patent No. 5750182

### SUMMARY OF THE INVENTION

The present disclosure has been made to solve the above-mentioned problems, and an object thereof is to provide a control method, an information processing device, and a non-transitory computer readable storage medium that enable a suggestion for collective control of a plurality of devices which obviates inconvenience to a user.

A control method by an information processing apparatus according to an aspect of the present disclosure includes: acquiring operation information on a group of operations continuously performed to a plurality of devices disposed in a facility; calculating an operation cost required to perform the group of operations indicated by the operation information; generating, in a case that the operation cost is larger than a predetermined value, suggestion information indicative of a suggestion for performing collective control of the group of operations indicated by the operation information to the devices; and outputting the suggestion information.

### BRIEF DESCRIPTION OF THE DRAWINGS

FIG. 1 is a block diagram showing an exemplary configuration of a collective control suggestion system according to an embodiment of the present disclosure.

FIG. 2 is a block diagram showing an exemplary configuration of a management server according to the embodiment of the present disclosure.

FIG. 3 is a block diagram showing an exemplary configuration of an operation terminal according to the embodiment of the present disclosure.

FIG. 4 is a table showing an exemplary data configuration of operation information.

FIG. 5 is a table showing an exemplary data configuration of operation group information.

FIG. 6 is a flowchart showing an exemplary process of the collective control suggestion system according to the embodiment of the present disclosure.

FIG. 7 is a flowchart showing an exemplary process of the collective control suggestion system according to the embodiment of the present disclosure.

FIG. 8A is an exemplary representation of suggestion information.

FIG. 8B is another exemplary representation of the suggestion information.

FIG. 9 is a flowchart showing an exemplary process executed by a processor of the management server according to the embodiment of the present disclosure.

FIG. 10 is a flowchart of an exemplary operation cost calculation in a first embodiment of the present disclosure.

FIG. 11 is a flowchart of an exemplary operation cost calculation in a second embodiment of the present disclosure.

FIG. 12 is a flowchart of an exemplary operation cost calculation in a third embodiment of the present disclosure.

FIG. 13 is a flowchart of an exemplary operation cost calculation in a fourth embodiment of the present disclosure.

FIG. 14 is a flowchart of an exemplary operation cost calculation in a fifth embodiment of the present disclosure.

FIG. 15 is a flowchart of an exemplary operation cost calculation in a sixth embodiment of the present disclosure.

FIG. 16 is a flowchart of an exemplary operation cost calculation in a seventh embodiment of the present disclosure.

FIG. 17 is a flowchart of an exemplary operation cost calculation in an eighth embodiment of the present disclosure.

FIG. 18 is a fatigue degree table in an exemplary data configuration.

FIG. 19 is a flowchart of an exemplary operation cost calculation in a ninth embodiment of the present disclosure.

FIG. 20 is a flowchart of an exemplary operation cost calculation in a tenth embodiment of the present disclosure.

### DETAILED DESCRIPTION

### Underlying Findings for Present Disclosure

In recent years, research has been carried out into a smart home that enables a resident to live a safer and more comfortable life by full use of technologies such as Internet of things (IoT) and artificial intelligence (AI). Additionally, there are more and more devices that are remotely controllable via a network. A user can operate a remotely controllable device using a controller and a switch proper to the device.

Patent Literature 1 discloses an invention that provides a user interface which enables efficient operations for a user to operate devices remotely and unitarily via a network through a control device such as a remote control device. The user interface that enables efficient operations in Patent Literature 1 is generated by determining a displaying priority on the basis of a physical distance between a home appliance control device and one home appliance or the number of executions of a home appliance operation command to the one home appliance.

However, the home appliance control device in Patent Literature 1 displays independent operation buttons corresponding to home appliance operation commands for respective home appliances on a display part. Therefore, collective control of simultaneously controlling a plurality of home appliances by single press on an operation button cannot be performed. Thus, there is a problem of the inconvenience to a user of pressing respective operation buttons for home appliances in order to simultaneously control the home appliances.

Patent Literature 2 discloses an interface to urge a user to collectively control lights and air conditioners disposed in a house upon a determination based on electric power consumption that it is desirable to save electric power.

However, it is difficult to say that the suggestion for the collective control disclosed in Patent Literature 2 is adapted to the life of the user, for there is a situation that makes a user feel like collectively controlling devices for a purpose other than the electric power saving. Specifically, there is a case where a user required to operate respective switches of devices to control the devices feels it inconvenient to individually operate the respective switches of the devices due to, e.g., a location of a switch and a time required to execute control. In such a case, the user may feel like collectively controlling the devices.

Therefore, the present inventors have made eager studies on the technique that enables a suggestion for collective control of a plurality of devices which obviates inconvenience that a user feels in operating the devices, thus achieving each aspect of the present disclosure described below.

A control method by an information processing apparatus according to an aspect of the present disclosure includes: acquiring operation information on a group of operations continuously performed to a plurality of devices disposed in a facility; calculating an operation cost required to perform the group of operations indicated by the operation information; generating, in a case that the operation cost is larger than a predetermined value, suggestion information indicative of a suggestion for performing collective control of the group of operations indicated by the operation information to the devices; and outputting the suggestion information.

This configuration enables suggesting performing collective control of a group of operations continuously performed to a plurality of devices in a case where an operation cost required to perform the group of operations is larger than a predetermined value. Thus, collective control of a plurality of devices that obviates inconvenience which a user feels in performing a group of operations can be suggested.

In the control method, in the acquisition of the operation information, information on a group of operations continuously performed to the devices with frequency greater than predetermined frequency during a predetermined period may be acquired as the operation information.

This configuration enables suggesting performing collective control of a group of operations continuously performed to a plurality of devices with frequency greater than predetermined frequency during a predetermined period in a case where an operation cost required to perform the group of operations is larger than a predetermined value. Thus, collective control of a plurality of devices that obviates inconvenience which a user feels in performing a group of operations can be suggested.

In the control method, the predetermined value may be an operation cost that was required to perform a group of operations indicated by suggestion information whose suggestion for collective control is accepted in the past, and that calculated for output of the suggestion information.

This configuration enables suggesting performing collective control of a group of operations continuously performed to a plurality of devices in a case where an operation cost required to perform the group of operations is larger than an operation cost that was calculated for output of suggestion information whose suggestion for collective control is accepted in the past.

Thus, a user can receive a suggestion for collective control in a case where the user performs a group of operations entailing an operation cost larger than an operation cost required to perform a group of operations indicated by suggestion information whose suggestion for collective control is accepted in the past. Accordingly, the probability can be increased that the user accepts the suggestion.

In the control method, the predetermined value may be arbitrarily determined by a user of the facility.

This configuration enables suggesting performing collective control of a group of operations continuously performed to a plurality of devices in a case where an operation cost required to perform the group of operations is larger than a value determined by a user of the facility.

Thus, a user of the facility determines an operation cost required to perform a group of operations that has made the user feel inconvenience as the predetermined value, which enables the user to receive a suggestion for collective control of a group of operations to a plurality of devices that seems to make the user feel inconvenience in a case where the user has performed the group of operations.

In the control method, the operation cost may be a time required to perform the group of operations indicated by the operation information.

This configuration enables an operator of a group of operations indicated by suggestion information to make a comparison as to whether a collective control of the group of operations to a plurality of devices can make a time required to perform the group of operations shorter than that required to individually perform.

In the control method, the operation cost may be the number of devices to which the group of operations indicated by the operation information is performed.

This configuration enables an operator of a group of operations indicated by suggestion information to make a comparison as to whether a collective control of the group of operations to a plurality of devices can make labor required to perform the group of operations lighter than that required to individually perform while changing the operated device.

In the control method, each of the devices disposed in the facility may be operated with a switch of the device or an operation screen included in an operation terminal disposed in the facility, and the operation cost may be the number of contacts by an operator with the switch or the operation screen from start to end of the group of operations indicated by the operation information.

This configuration enables an operator of a group of operations indicated by suggestion information to make a comparison as to whether a collective control of the group of operations to a plurality of devices can make labor required to perform the group of operations lighter than that required to perform while coming into contact with the switch of each of the devices or the operation screen.

In the control method, the operation cost may be the number of operations that are included in the group of operations indicated by the operation information and are unnecessary in view of specifications of the devices receiving the group of operations.

This configuration enables a determination as to whether to suggest collective control of a group of operations continuously performed to a plurality of devices disposed in a facility based on the number of operations that are included in the group of operations and are unnecessary in view of specifications.

In the control method, the operation cost may be a movement distance of an operator performing the group of operations from start to end of the group of operations indicated by the operation information.

This configuration enables an operator of a group of operations indicated by suggestion information to make a comparison as to whether a collective control of the group of operations to a plurality of devices can reduce a movement distance from start to end of the group of operations.

In the control method, a sum of distances between respective performance positions of the operations in the group of operations indicated by the operation information may be calculated as the movement distance.

This configuration enables an operator of a group of operations indicated by suggestion information to make a comparison as to whether a collective control of the group of operations to a plurality of devices can reduce a movement distance required to perform the group of operations.

In the control method, a length of a traffic line of the operator from the start to the end of the group of operations indicated by the operation information may be calculated as the movement distance.

In this configuration, a position at which an operator of a group of operations indicated by suggestion information was present in order to perform a task other than the operations to the devices while moving between respective performance positions of operations is taken into account. Thus, a more exact movement distance of the operator from start to end of the group of operations can be calculated. Therefore, the operator can make a more accurate comparison as to whether a collective control of the group of operations to a plurality of devices can reduce a movement distance required to perform the group of operations.

In the control method, the traffic line of the operator may be acquired on the basis of information indicative of visit positions of the operator acquired by a sensor disposed in the facility.

This configuration enables acquisition of an exact traffic line of the operator based on information indicative of visit positions of the operator acquired by a sensor disposed in the facility.

In the control method, a sum of distances between a place where the operator stays in the facility for a longest time and respective performance positions of the operations in the group of operations indicated by the operation information may be calculated as the movement distance.

This configuration enables calculation of an operation cost adapted to behavior in daily life of an operator of a group of operations indicated by suggestion information. Thus, the operator can make an appropriate comparison as to whether a collective control of the group of operations to a plurality of devices can reduce a movement distance required to perform the group of operations.

In the control method, the place where the operator stays in the facility for the longest time may be acquired on the basis of information indicative of visit positions of the operator acquired by a sensor disposed in the facility.

This configuration enables acquisition of the exact place where the operator stays in the facility for the longest time based on information indicative of visit positions of the operator acquired by a sensor disposed in the facility.

In the control method, the operation cost may be a fatigue degree indicative of a load on a body of the operator in performing the group of operations indicated by the operation information.

This configuration enables an operator of a group of operations indicated by suggestion information to make a comparison as to whether a collective control of the group of operations to a plurality of devices can reduce a load on the body in performing the group of operations.

In the control method, the fatigue degree may be set to be larger as an average value of differences between a height of the operator and heights from a floor surface to respective performance positions of the operations in the group of operations indicated by the operation information becomes larger.

In this configuration, a fatigue degree, which is set to be larger as an average value of differences between a height of an operator of a group of operations indicated by operation information and heights from a floor surface to respective performance positions of the operations in the group of operations becomes larger, is calculated as the operation cost.

Therefore, the operator of the group of operations indicated by the suggestion information can make an appropriate comparison as to whether a collective control of the group of operations to a plurality of devices can reduce a load on the body of the operator according to the differences between the height of the operator and the heights from the floor surface to the respective performance positions of the operations in the group of operations.

In the control method, each of the devices disposed in the facility may be operated with a switch of the device or an operation screen included in an operation terminal disposed in the facility, and the operation cost may be a sum of a movement time required to move between switches used for the group of operations indicated by the operation information and required times to control the operations in the group of operations to the devices.

This configuration enables an operator of a group of operations indicated by suggestion information to make a comparison as to whether a collective control of the group of operations to a plurality of devices can reduce a time required to complete the control of the devices while moving to perform all of the operations in the group of operations.

In the control method, in the calculation of the operation cost: in a case that there is at least one calculation method that was used for output of one or more suggestion information pieces whose suggestion was accepted with a probability not lower than a certain threshold among one or more calculation methods that were used to calculate an operation cost in the past, the operation cost may be calculated by a calculation method indicating the highest probability among the one or more calculation methods; and in a case that there is not the at least one calculation method, the operation cost may be calculated by a calculation method different from the one or more calculation methods.

This configuration enables calculation of an operation cost by a calculation method to maximize the probability that a suggestion is accepted.

An information processing apparatus according to another aspect of the present disclosure includes: an acquisition part for acquiring operation information on a group of operations continuously performed to a plurality of devices disposed in a facility; a calculation part for calculating an operation cost required to perform the group of operations indicated by the operation information; a generation part for generating, in a case that the operation cost is larger than a predetermined value, suggestion information indicative of a suggestion for performing collective control of the group of operations indicated by the operation information to the devices; and an output part for outputting the suggestion information.

This configuration exerts the same advantageous effects as those described for the control method.

A non-transitory computer readable storage medium according to another aspect of the present disclosure is a non-transitory computer readable storage medium storing a program that causes a computer to serve as: an acquisition part for acquiring operation information on a group of operations continuously performed to a plurality of devices disposed in a facility; a calculation part for calculating an operation cost required to perform the group of operations indicated by the operation information; a generation part for generating, in a case that the operation cost is larger than a predetermined value, suggestion information indicative of a suggestion for performing collective control of the group of operations indicated by the operation information to the devices; and an output part for outputting the suggestion information.

This configuration exerts the same advantageous effects as those described for the control method.

The disclosure can be realized as a system operated by the program. Additionally, it goes without saying that the program is distributable as a non-transitory computer readable storage medium like a CD-ROM, or distributable via a communication network like the Internet.

Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### FIRST EMBODIMENT

Embodiments of a control method, an information processing apparatus, and a program according to the present disclosure will be described below with reference to the drawings. In the embodiments below, the same parts are denoted by the same reference numerals to omit duplicate description.

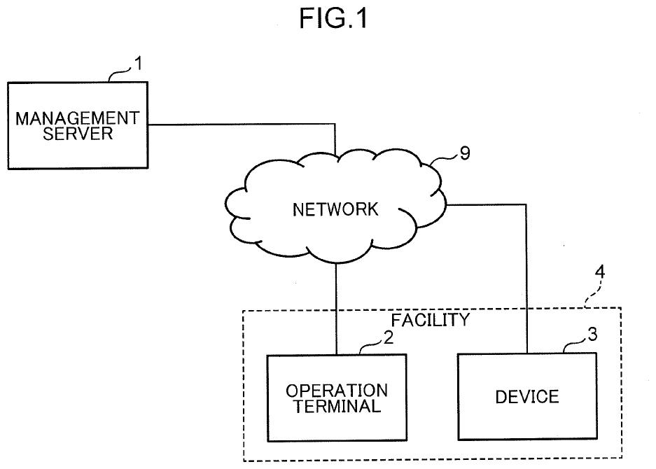

FIG. 1 is a block diagram showing an exemplary configuration of a collective control suggestion system according to an embodiment of the present disclosure. The collective control suggestion system includes a management server 1 (an exemplary information processing apparatus), an operation terminal 2, and a device 3. The management server 1, the operation terminal 2, and the device 3 are communicably connected with each other via a network 9. The network 9 is, e.g., a wide area network including the Internet and a mobile phone communication network.

A facility 4 is provided with a plurality of devices 3 and an operation terminal 2. The collective control suggestion system has a function of suggesting collective control of devices 3 disposed in the facility 4. The facility 4 is provided with, e.g., devices 3 of the same type such as respective shutters installed for windows of the facility 4. The facility 4 maybe provided with, e.g., devices 3 of different types such as a shutter and a lighting device.

The facility 4 is, for example, a house. The house is a multifamily residential, or may be a detached house. The facility 4 maybe an office. In a case where the facility 4 is a house, a resident operates a device 3 and an operation terminal 2. In a case where the facility 4 is an office, an employer of the office operates a device 3 and an operation terminal 2. Hereinafter, a resident of the house and an employer of the office are referred to as the user.

The management server 1 is a server for executing information processing to suggest collective control of devices 3 to the user. The management server 1 stores information necessary for the suggestion, and executes various kinds of information processing necessary for the suggestion. The management server 1 is, e.g., a server device including a computer or a cloud server including one or more computers.

The user can control devices 3 collectively or individually through the operation terminal 2. The collective control of devices 3 is to simultaneously control the devices 3 by single operation to the operation terminal 2. The individual control of devices 3 is to individually control the devices 3 by respective operations to the operation terminal 2.

The operation terminal 2 accepts an operation for a device 3 performed by the user, and transmits to the device 3 an execution instruction for control of the device 3 associated with the accepted operation. The operation terminal 2 is, e.g., a stationary information terminal or a wall-embedded information terminal. The operation terminal 2 maybe a mobile terminal of the user, e.g., a smartphone or a tablet.

The device 3 includes, e.g., an electric device with a communication function such as an IoT device. The device 3 includes an electric device that is powered on and off by the user, but excludes an electric device that is always powered on, e.g., a refrigerator; for example, the device 3 is a personal computer, a television, a shutter, a light, or an air conditioner.

The device 3 is controlled by the user operating the operation terminal 2 or a switch proper to the device 3. The switch proper to the device 3 includes, e.g., a push switch placed on a wall surface of the facility 4 such as a switch for turning on and off a light. The switch proper to the device 3 includes, e.g., a remote controller dedicated to the device 3. Hereinafter, a switch proper to a device 3 is briefly referred to as the switch of the device 3.

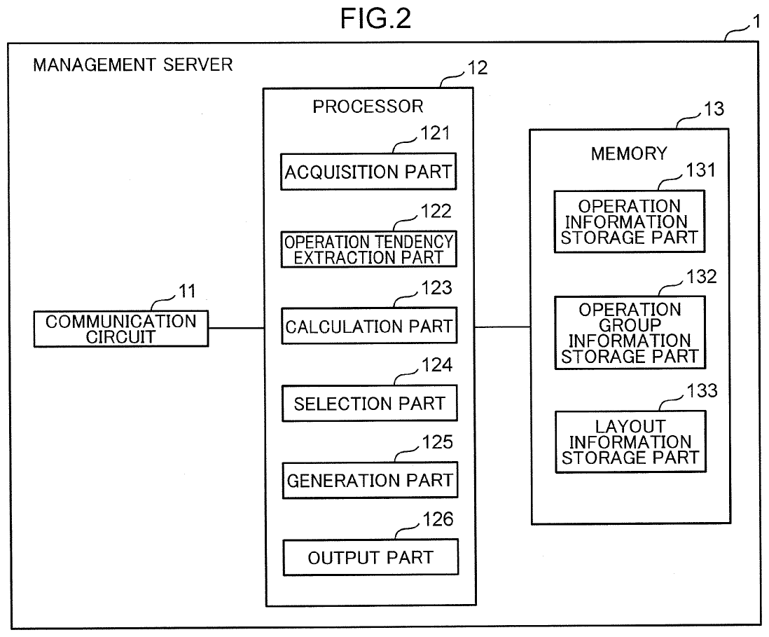

FIG. 2 is a block diagram showing an exemplary configuration of the management server 1 according to the embodiment of the present disclosure. The management server 1 includes a communication circuit 11, a processor 12 (an exemplary computer), and a memory 13.

The communication circuit 11 is a communication interface circuit compatible with a communication system by use of a network 9 such as Ethernet (registered trademark), and connects the management server 1 to the network 9. The communication circuit 11 receives various kinds of information from the devices 3 and the operation terminal 2 through the network 9 and outputs the information to the processor 12. The communication circuit 11 transmits the various kinds of information to an external device connected to the network 9 through the network 9 under control by the processor 12.

The processor 12 is an integrated circuit, e.g., a central processing unit (CPU) or a field programmable gate array (FPGA). An execution of a control program stored in the memory 13 causes the processor 12 to function as an acquisition part 121, an operation tendency extraction part 122, a calculation part 123, a selection part 124, a generation part 125, and an output part 126.

The acquisition part 121 acquires information received by the communication circuit 11 from the operation terminal 2 and the devices 3 through the network 9. The acquisition part 121 also acquires information stored in the memory 13.

The information received from the operation terminal 2 includes, e.g., information (hereinafter, operation information) on an operation to a device 3 performed by the user with the operation terminal 2. The information received from the operation terminal 2 also includes information (hereinafter, adoption information) indicating whether the user has accepted collective control of devices 3 suggested by the management server 1. The information received from a device 3 includes, e.g., operation information on an operation performed by the user with a switch proper to the device 3. The details of the operation information and the adoption information will be described later. The acquisition part 121 stores, when acquiring operation information, the operation information in an operation information storage part 131 which will be described later.

The operation tendency extraction part 122 extracts a group of operations continuously performed to a plurality of devices 3 disposed in the facility 4 as a group of operations that requires a determination as to whether to suggest collective control. The group of operations continuously performed means a plurality of operations performed within a certain time (e.g., five minutes).

Specifically, the operation tendency extraction part 122 refers to the operation information stored in the operation information storage part 131 described later, and extracts a group of operations continuously performed to a plurality of devices 3 with frequency greater than predetermined frequency during a predetermined period as the group of operations that requires the determination as to whether to suggest collective control.

For example, the predetermined period is set to be one month, and the predetermined frequency is set to be once a week; operations for closing all the shutters installed in the facility 4 within a certain time (e.g., five minutes) are performed at sunset every day during one month to execute control for closing all the shutters; and this can be recognized by reference to the operation information stored in the operation information storage part 131.

In this example, the operation tendency extraction part 122 determines that a determination is required as to whether to suggest collective control of the closing of all the shutters that is performed with the frequency greater than the predetermined frequency for one month. The operation tendency extraction part 122 then extracts the operations for closing all the shutters performed within the certain time to execute the control for closing all the shutters as the group of operations that requires the determination as to whether to suggest collective control. The predetermined period and the predetermined frequency may be set appropriately by the user operating the management server 1.

The operation tendency extraction part 122 may extract a group of operations that has been only once performed to a plurality of devices 3 within a certain time as the group of operations that requires the determination as to whether to suggest collective control.

The calculation part 123 calculates an operation cost required to perform the group of operations extracted by the operation tendency extraction part 122. The operation cost is, e.g., a necessary duration between a time when the first operation in the group of operations extracted by the operation tendency extraction part 122 is performed and a time when the last operation in the group of operations is performed. The way of calculating the operation cost is not limited to this. The details of the calculation method of the operation cost will be described later.

The selection part 124 compares the operation cost calculated by the calculation part 123 with a predetermined value, and determines on the basis of a result of the comparison whether to suggest collective control of the group of operations to the devices 3 extracted by the operation tendency extraction part 122.

Specifically, the selection part 124 determines to suggest the collective control of the group of operations to the devices 3 extracted by the operation tendency extraction part 122 in a case where the operation cost calculated by the calculation part 123 is larger than the predetermined value. The predetermined value is set on the basis of, e.g., contents of a suggestion that has been accepted by the user in the past.

In a case where the selection part 124 determines to suggest the collective control, the generation part 125 generates suggestion information indicative of a suggestion for the collective control of the group of operations to the devices 3 extracted by the operation tendency extraction part 122.

Specifically, the suggestion information has identification information of the devices 3 receiving the respective operations included in the group of operations extracted by the operation tendency extraction part 122 and information indicative of control contents of the devices 3 based on the respective operations. The suggestion information also has information (hereinafter, frequency information) on frequency of performances of a group of operations extracted by the operation tendency extraction part 122, e.g., how many times the group of operations is performed during the predetermined period.

The output part 126 outputs the suggestion information generated by the generation part 125. Specifically, the output part 126 transmits the suggestion information to the operation terminal 2 through the communication circuit 11.

The memory 13 is a storage device, e.g., a hard disk drive or a solid state drive. The memory 13 includes an operation information storage part 131, an operation group information storage part 132, and a layout information storage part 133.

The operation information storage part 131 stores the operation information acquired by the acquisition part 121. When the user performs an operation to a device 3 disposed in the facility 4, operation information on the operation is stored in the operation information storage part 131 as new data. The details of the operation information will be described later.

The operation group information storage part 132 stores information (hereinafter, operation group information) on the group of operations that has been extracted by the operation tendency extraction part 122 in the past. When the operation tendency extraction part 122 extracts a group of operations that requires the determination as to whether to suggest collective control, operation group information on the group of operations is stored in the operation group information storage part 132 as new data. The details of the operation group information will be described later.

The layout information storage part 133 stores layout information indicative of a layout of the facility 4. The layout information includes, e.g., information indicative of a layout of a division and a room in the facility 4, identification information of a device 3 and an operation terminal 2 disposed in the division or the room, disposed positions of the device 3 and the operation terminal 2, and a disposed position of a switch of the device 3. The disposed position is represented by, e.g., a latitude, a longitude, and an altitude.

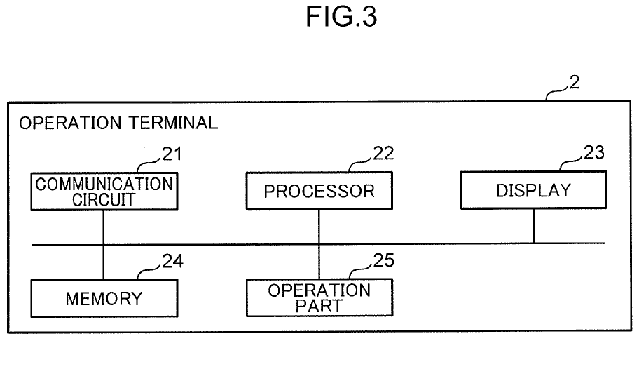

FIG. 3 is a block diagram showing an exemplary configuration of the operation terminal 2 according to the embodiment of the present disclosure. The operation terminal 2 includes a communication circuit 21, a display 23, a memory 24, an operation part 25, and a processor 22.

The communication circuit 21 is a communication interface circuit compatible with a communication system by use of the network 9 such as Ethernet (registered trademark), and connects the operation terminal 2 to the network 9.

The display 23 is a display device, e.g., a liquid crystal display or an organic electro-luminescence display. The display 23 displays an operation screen for the devices 3 disposed in the facility 4 under control by the processor 22. The operation screen has, e.g., a soft key for performing an operation of transitioning an operation screen to another one and a soft key associated with control of a device 3.

The memory 24 is a rewritable non-volatile storage device such as a flash memory.

The operation part 25 includes, e.g., a touchscreen device, a mouse, and a keyboard. The operation part 25 accepts an operation of a soft key displayed on the display 23.

The processor 22 is, e.g., a CPU, and controls the entirety of the operation terminal 2. For example, when the operation part 25 accepts an operation of a soft key associated with control of a device 3, the processor 22 determines that the user has performed an operation for the device 3, and transmits to the device 3 an execution instruction for the control of the device 3 associated with the soft key through the communication circuit 21. The device 3 receives the execution instruction and thus the control of the device 3 indicated by the execution instruction is executed. The processor 22 transmits operation information on the operation for the device 3 performed by the user to the management server 1 through the communication circuit 21.

The processor 22 causes, when the communication circuit 21 receives suggestion information from the management server 1, the display 23 to display the suggestion information. Thus, the user can consider whether to accept to perform collective control of the group of operations to the devices 3 indicated by the suggestion information by viewing the suggestion information displayed on the display 23.

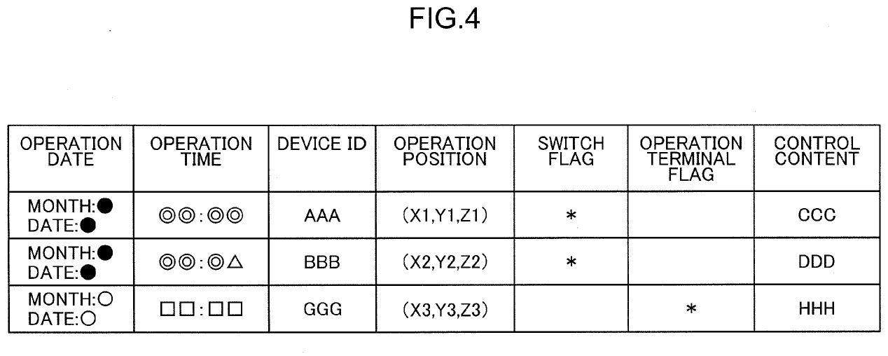

Next, a data configuration of the operation information will be described. FIG. 4 is a table showing an exemplary data configuration of the operation information. The operation information is generated when the user performs an operation to a device 3 with the device 3 or the operation terminal 2, and is transmitted to the management server 1. The acquisition part 121 acquires the operation information received from the device 3 or the operation terminal 2, and stores the operation information in the operation information storage part 131. The operation information includes an operation date, an operation time, a device ID, an operation position, a switch flag, an operation terminal flag, and a control content.

The operation date and the operation time indicates a date and a time when an operation is performed to a device 3, respectively. For example, a date and a time when the user finishes an operation to a device 3 with a switch or the operation terminal 2 are set as the operation date and the operation time, respectively. The device ID is identification information of the device 3. For example, a product name of the device 3, a model number of the device 3, or an original name given by the user to the device 3 is set as the device ID.

The operation position indicates a performance position of the operation to the device 3 by the user. For example, a three-dimensional value indicative of a latitude, a longitude, and an altitude of the performance position of the operation to the device 3 by the user is set as the operation position. The operation position is not limited to this, and may be a two-dimensional value indicative of the latitude and the longitude of the performance position of the operation to the device 3 by the user.

In a case where the user performs an operation to a device 3 with a switch of the device 3, a three-dimensional or two-dimensional value indicative of the position of the switch of the device 3 is set as the operation position. On the other hand, in a case where the user performs an operation to the device 3 with the operation terminal 2, a three-dimensional or two-dimensional value indicative of the position of the operation terminal 2 is set as the operation position.

The acquisition part 121 may acquire, when acquiring operation information received from a device 3, a disposed position of a switch of the device 3 associated with a device ID in the operation information by reference to the layout information storage part 133, and set the acquired disposed position as the operation position for the operation information.

The switch flag is a flag that indicates whether the user has used a switch of a device 3 to perform an operation to the device 3. A symbol “*” is set in the switch flag when the user uses a switch of a device 3 to perform an operation to the device 3.

The operation terminal flag is a flag that indicates whether the user has used the operation terminal 2 to perform an operation to a device 3. The symbol “*” is set in the operation terminal flag when the user uses the operation terminal 2 to perform an operation to the device 3. In a case where the facility 4 is provided with a plurality of operation terminals 2 each of which is a stationary information terminal, a wall-embedded information terminal, or a mobile terminal of the user such as a smartphone and a tablet, a symbol or a number identifying an operation terminal 2 used by the user to perform an operation to a device 3 maybe set in the operation terminal flag.

The control content indicates a content of control of a device 3 executed according to an operation to the device 3. The data configuration of the operation information is not limited to the data configuration shown in FIG. 4; the operation information may have other information.

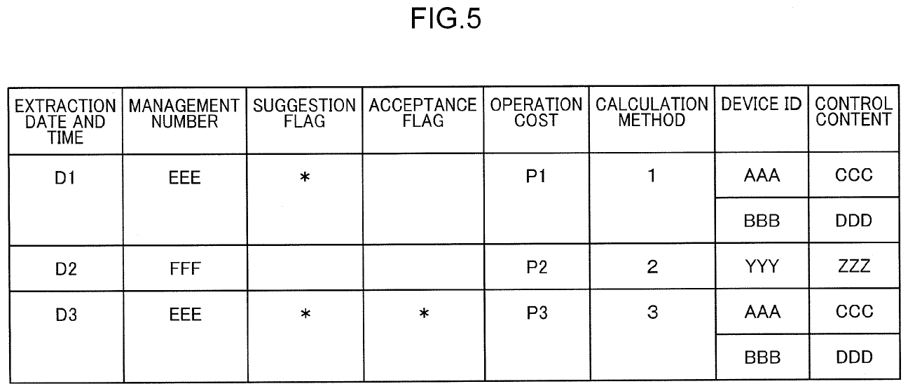

Next, a data configuration of the operation group information stored in the operation group information storage part 132 will be described. FIG. 5 is a table showing an exemplary data configuration of the operation group information. The operation group information has an extraction date and time, a management number, a suggestion flag, an acceptance flag, an operation cost, a calculation method, a device ID, and a control content.

The extraction date and time is a date and time when a group of operations that requires the determination as to whether to suggest collective control is extracted by the operation tendency extraction part 122.

The management number is a number identifying a group of operations extracted by the operation tendency extraction part 122. Therefore, groups of operations different from each other are assigned with different management numbers. In FIG. 5, a group of operations extracted on an extraction date and time “D1” and a group of operations extracted on an extraction date and time “D3” after the extraction date and time “D1” both represent an operation for executing control indicated by a control content “CCC” to a device 3 identified with a device ID “AAA” and an operation for executing control indicated by a control content “DDD” to a device 3 identified with a device ID “BBB”. Therefore, these two groups of operations are assigned with the same management number “EEE”.

The suggestion flag is a flag indicative of a result of a determination by the selection part 124 of the processor 12. In a case where the selection part 124 determines to suggest collective control of a group of operations to a plurality of devices 3 extracted by the operation tendency extraction part 122, the symbol “*” is stored in the suggestion flag of operation group information corresponding to the group of operations.

The acceptance flag is a flag that indicates whether the user has accepted, when receiving a suggestion for collective control of a group of operations to a plurality of devices 3 extracted by the operation tendency extraction part 122, the suggested collective control.

Specifically, in a case where the user receives a suggestion for collective control of a group of operations to a plurality of devices 3 extracted by the operation tendency extraction part 122 and accepts the suggested collective control, the symbol “*” is stored in the suggestion flag of operation group information corresponding to the group of operations, and the symbol “*” is stored in the acceptance flag of the operation group information.

On the other hand, in a case where the user receives a suggestion for collective control of a group of operations to a plurality of devices 3 extracted by the operation tendency extraction part 122, but does not accept the suggested collective control, the symbol “*” is stored in the suggestion flag of operation group information corresponding to the group of operations, but the acceptance flag of the operation group information is blank.

For example, FIG. 5 shows that the user has received a suggestion for collective control of the group of operations to a plurality of devices 3 extracted on the extraction date “D1”, but has not accepted the suggested collective control. FIG. 5 also shows that the user has received a suggestion for collective control of the same group of operations to the devices 3 extracted on the extraction date “D3” after the extraction date “D1” as the group of operations extracted on the extraction date “D1”, and has accepted the suggested collective control.

In a case where the selection part 124 determines not to suggest collective control of a group of operations to a plurality of devices 3 extracted by the operation tendency extraction part 122, the collective control is not suggested and thus the acceptance flag of operation group information corresponding to the group of operations is blank.

The operation cost is a cost required to perform a group of operations extracted by the operation tendency extraction part 122. The operation cost is calculated by the calculation part 123.

“Calculation Method” refers to identification information of a calculation method of an operation cost by the calculation part 123. Specifically, in “Calculation Method”, stored is identification information of respective calculation methods of operation cost shown in the first embodiment and the second to ninth embodiments described later. For example, in FIG. 5, “2” is stored in “Calculation Method” because “P2” in “Operation Cost” is calculated by a calculation method of operation cost shown in the second embodiment.

“Device ID” refers to identification information of each of the devices 3 receiving the group of operations extracted by the operation tendency extraction part 122. In “Device ID”, stored are a product name of a device 3, a model number of the device 3, an original name given by the user to the device 3, or the like, for example.

“Control Content” indicates a content of control of one of a group of operations extracted by the operation tendency extraction part 122 to a device 3. In “Control Content”, stored is information indicative of powering on or off a device 3, for example.

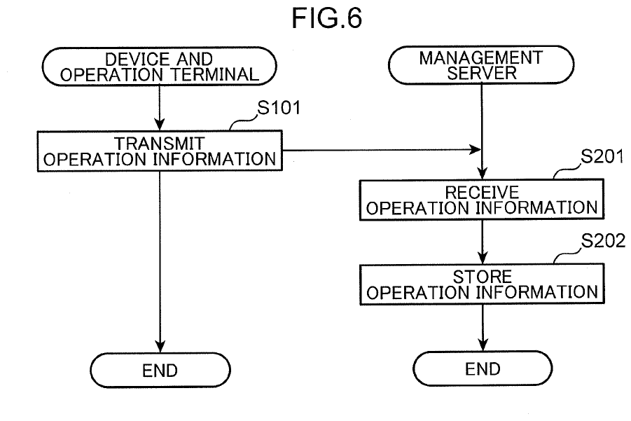

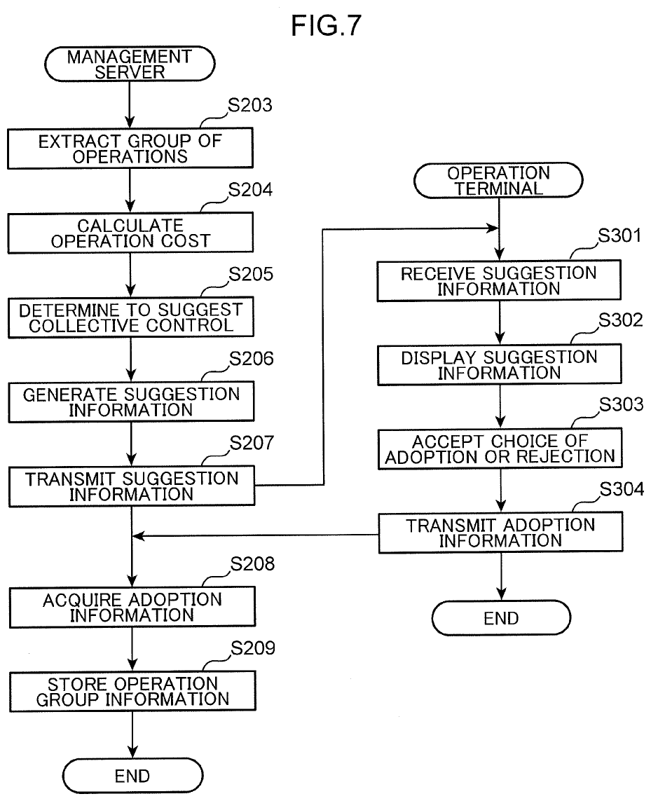

Next, a process executed in the collective control suggestion system will be described. Each of FIGS. 6 and 7 is a flowchart showing an exemplary process of the collective control suggestion system according to the embodiment of the present disclosure. First, a process of storing operation information transmitted by a device 3 or the operation terminal 2 in the management server 1 will be described with reference to FIG. 6. The process shown in FIG. 6 is executed every time the user operates a device 3. Each step shown in FIG. 6 will be described below.

### Step S101

When the user performs an operation to a device 3 with a switch of the device 3, the device 3 transmits operation information on the operation to the management server 1. When the user performs an operation to the device 3 with the operation terminal 2, the operation terminal 2 transmits operation information on the operation to the management server 1.

### Step S201

The communication circuit 11 of the management server 1 receives the operation information transmitted in Step S101.

### Step S202

The acquisition part 121 acquires the operation information received in Step S201, and stores the acquired operation information in the operation information storage part 131 of the memory 13.

Next, a process that is executed in the collective control suggestion system when the management server 1 suggests collective control of a plurality of devices 3 will be described with reference to FIG. 7. The process shown in FIG. 7 is executed periodically, e.g., once a month. The frequency with which the process shown in FIG. 7 is executed may be arbitrarily set by the user. Each step shown in FIG. 7 will be described below.

### Step S203

The operation tendency extraction part 122 in the management server 1 extracts a group of operations that requires the determination as to whether to suggest collective control.

### Step S204

The calculation part 123 calculates an operation cost required to perform the group of operations extracted in Step S203.

### Step S205

The selection part 124 determines to suggest collective control of the group of operations to a plurality of devices 3 extracted in Step S203 in a case where the operation cost calculated in Step S204 is larger than a predetermined value.

### Step S206

The generation part 125 generates suggestion information indicative of a suggestion for collective control of the group of operations to the devices 3 extracted in Step S203.

### Step S207

The output part 126 transmits the suggestion information generated in Step S206 to the operation terminal 2 through the communication circuit 11.

### Step S301

The communication circuit 21 of the operation terminal 2 receives the suggestion information transmitted in Step S207.

### Step S302

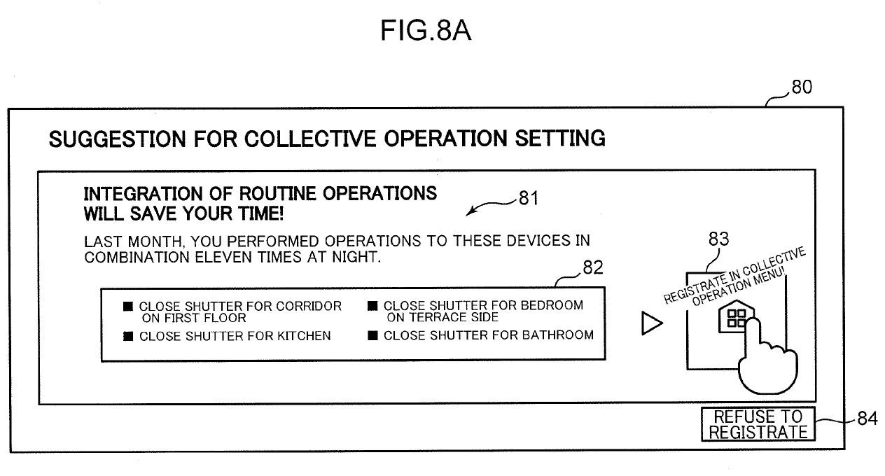

The processor 22 causes the display 23 to display the suggestion information received in Step S301. FIG. 8A is an exemplary representation of the suggestion information. For example, as shown in FIG. 8A, the processor 22 causes the display 23 to display an operation screen 80 including the suggestion information. The operation screen 80 has a first display field 81, a second display field 82, an adoption button 83, and a non-adoption button 84.

The first display field 81 shows the frequency information included in the suggestion information. The second display field 82 shows information that is included in the suggestion information and that indicates device IDs of the devices 3 to which the respective operations in the group of operations extracted by the operation tendency extraction part 122 are performed, and control contents of the respective operations to the devices 3. The adoption button 83 is a soft key for performing an operation of accepting a suggestion indicated by suggestion information.

The non-adoption button 84 is a soft key for performing an operation of rejecting a suggestion indicated by suggestion information.

### Step S303

The user chooses to accept or not to accept the suggestion indicated by the suggestion information by pressing the adoption button 83 or the non-adoption button 84 using the operation part 25. The processor 22 accepts adoption information indicative of the choice by the user.

Specifically, in a case where the user presses the adoption button 83, the processor 22 accepts adoption information indicative of acceptance of the suggestion indicated by the suggestion information. On the other hand, in a case where the user presses the non-adoption button 84, the processor 22 accepts adoption information indicative of rejection of the suggestion indicated by the suggestion information.

### Step S304

The operation terminal 2 transmits the adoption information accepted in Step S303 to the management server 1 through the communication circuit 21.

### Step S208

In the management server 1, when the communication circuit 11 receives the adoption information transmitted in Step S304, the acquisition part 121 acquires the adoption information received by the communication circuit 11.

### Step S209

The acquisition part 121 of the management server 1 stores operation group information on the group of operations extracted in Step S203 in the operation group information storage part 132, which is based on the result of the determination in Step S205 and the adoption information acquired in Step S208.

Specifically, in Step S209, the acquisition part 121 stores the symbol “*” in the suggestion flag of the operation group information in a case where it is determined in Step S205 to suggest collective control of the group of operations to the devices 3 extracted in Step S203.

The acquisition part 121 stores the symbol “*” in the acceptance flag of the operation group information when acquiring adoption information indicative of acceptance of a suggestion indicated by suggestion information in Step S208. On the other hand, the acquisition part 121 does not store the symbol “*” in the acceptance flag of the operation group information when acquiring adoption information indicative of rejection of a suggestion indicated by suggestion information in Step S208. Thus, the acceptance flag of the operation group information is blank.

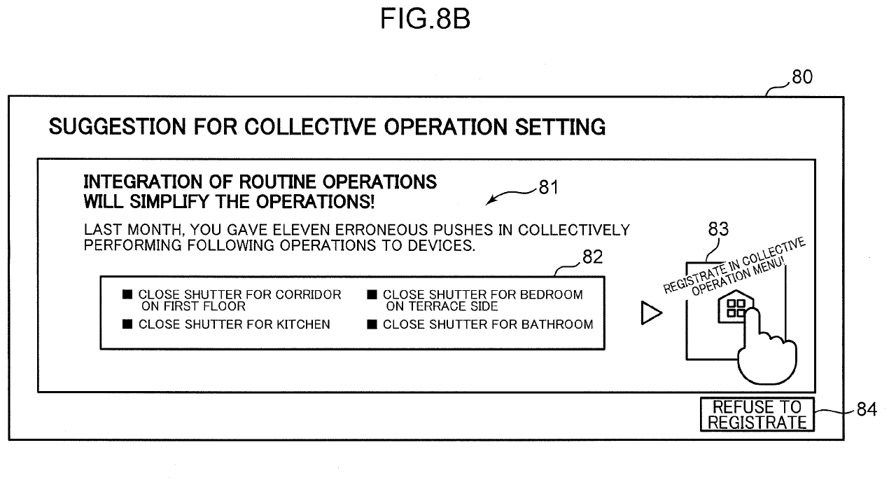

Next, a process by the processor 12 of the management server 1 will be described. FIG. 9 is a flowchart showing an exemplary process executed by the processor 12 of the management server 1 according to the embodiment of the present disclosure. Each step shown in FIG. 9 will be described below.

### Step S401

The acquisition part 121 acquires the operation information received by the communication circuit 11, and stores the acquired operation information in the operation information storage part 131. This procedure corresponds to Step S202 described above.

### Step S402

The operation tendency extraction part 122 extracts the group of operations that requires the determination as to whether to suggest collective control. This procedure corresponds to Step S203 described above. In a case where a plurality of groups of operations is extracted in Step S402, each of the groups of operations receives the procedures following Step S403.

### Step S403

The calculation part 123 calculates the operation cost required to perform the group of operations extracted in Step S402. This procedure corresponds to Step S204 described above.

### Step S404

The selection part 124 determines whether the operation cost calculated in Step S403 is larger than the predetermined value. This procedure corresponds to Step S205 described above.

In a case where it is determined in Step S404 that the operation cost is larger than the predetermined value (YES in Step S404), procedures following Step S405 are executed.

### Step S405

The generation part 125 generates the suggestion information indicative of the suggestion for collective control of the group of operations to the devices 3 extracted in Step S402. This procedure corresponds to Step S206 described above.

### Step S406

The output part 126 transmits the suggestion information generated in Step S405 to the operation terminal 2 through the communication circuit 11. This procedure corresponds to Step S207 described above.

### Step S407

When the communication circuit 11 receives the adoption information transmitted from the operation terminal 2, the acquisition part 121 acquires the adoption information received by the communication circuit 11. This procedure corresponds to Step S208 described above.

Step S408 is executed after Step S407 or in a case where it is determined in Step S404 that the operation cost is not larger than the predetermined value (NO in Step S404).

### Step S408

The acquisition part 121 stores operation group information on the group of operations extracted in Step S402 in the operation group information storage part 132, which is based on the result of the determination in Step S404 and the adoption information acquired in Step S407. This procedure corresponds to Step S209 described above.

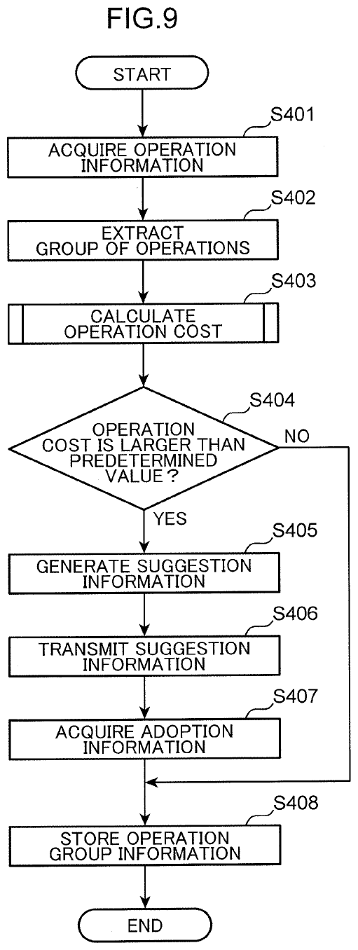

Next, a calculation (hereinafter, operation cost calculation) of the operation cost by the calculation part 123 in Step S404 will be described. The calculation part 123 calculates a time required to perform the group of operations extracted in Step S402 as the operation cost. FIG. 10 is a flowchart of an exemplary operation cost calculation in the first embodiment of the present disclosure. Each step shown in FIG. 10 will be described below.

### Step S501

The calculation part 123 acquires an operation time of each of the operations in the group of operations extracted in Step S402. The respective operation times for the devices 3 can be acquired by reference to the operation information (FIG. 4) stored in the operation information storage part 131.

### Step S502

The calculation part 123 calculates a difference between an operation time of the first operation and an operation time of the last operation among the respective operation times acquired in Step S501 of the operations in the group of operations extracted in Step S402 as the operation cost. Thus, the time required to perform the group of operations extracted in Step S402 can be calculated.

Since the difference between the operation time of the first operation and the operation time of the last operation is calculated as the operation cost in Step S502 by reference to operation times stored in the operation information storage part 131, the operation cost can include, in an exemplary case where the user performs the group of operations extracted in Step S402 with respective switches of devices 3, a time to move between the respective switches of the devices 3.

The operation cost calculated in Step S502 is used to be compared with the predetermined value in Step S404. The predetermined value in the embodiment is, e.g., a time that was required to perform a group of operations indicated by suggestion information whose suggestion was accepted by the user in the past, and calculated as the operation cost required to perform the group of operations in the generation of the suggestion information.

The predetermined value is not limited to this, and may be arbitrarily determined by the user. Alternatively, the predetermined value may be a time required to give control start instructions to the devices 3 collectively for starting the control of the group of operations to the devices 3 extracted in Step S402. Specifically, the time corresponds to a time required to perform an operation of transitioning a predetermined home screen displayed on the display 23 of the operation terminal 2 to an operation screen having a soft key for performing an operation of giving the control start instructions to the devices 3 collectively.

As described above, in the first embodiment, the calculated operation cost required to perform the group of operations extracted as the group of operations that requires the determination as to whether to suggest the collective control includes the time required to move between respective switches of devices 3. Therefore, the first embodiment enables a comparison as to whether a collective control of an extracted group of operations to a plurality of devices 3 can make a time required to perform the group of operations shorter than that required to individually perform the group of operations while moving between respective switches of devices 3.

### SECOND EMBODIMENT

Hereinafter, a second embodiment according to the present disclosure will be described with reference to the drawings. In the second embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

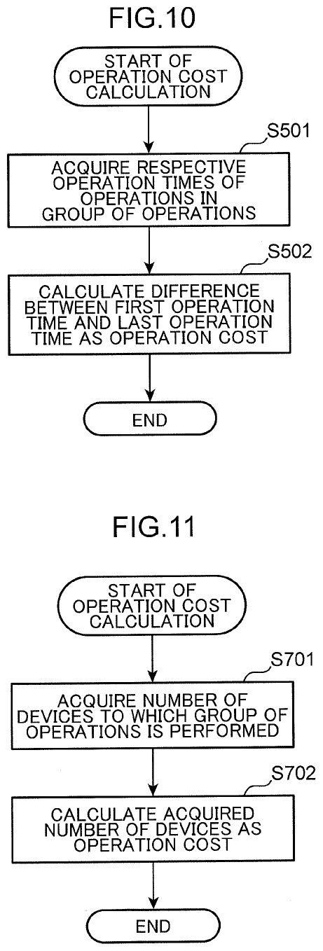

In the second embodiment, the calculation part 123 calculates the number of devices 3 to which the group of operations extracted in Step S402 is performed as the operation cost. FIG. 11 is a flowchart of an exemplary operation cost calculation in the second embodiment of the present disclosure. Each step shown in FIG. 11 will be described below.

### Step S701

The calculation part 123 acquires the number of devices 3 to which the group of operations extracted in Step S402 is performed. The number of the devices 3 can be acquired by reference to the operation information (FIG. 4) stored in the operation information storage part 131.

In a case where an identical device 3 among the devices 3 receives operations in the group extracted in Step S402, the calculation part 123 may acquire the number of devices 3 for the identical device as one. In other words, the calculation part 123 may avoid the duplication for the identical device 3 in the acquisition of the number of the devices 3 receiving the group of operations extracted in Step S402.

In a case where an identical device 3 among the devices 3 receives operations in the group extracted in Step S402, and the operations to the identical device 3 includes an operation performed by use of a switch to the device 3 and an operation performed by use of the operation terminal 2 to the device 3, the calculation part 123 may acquire the number of devices 3 for the identical device as two. In other words, the calculation part 123 may avoid the duplication for the identical device 3 and the duplication for the implements used to operate the device 3 in the acquisition of the number of the devices 3 receiving the group of operations extracted in Step S402.

### Step S702

The calculation part 123 calculates the number of the devices 3 acquired in Step S701 as the operation cost.

The operation cost calculated in Step S702 is used to be compared with the predetermined value in Step S404. The predetermined value in the embodiment is, e.g., the number of devices 3 receiving a group of operations indicated by suggestion information whose suggestion was accepted by the user in the past, which was calculated as the operation cost required to perform the group of operations in the generation of the suggestion information. The predetermined value is not limited to this, and may be arbitrarily determined by the user.

As described above, in the second embodiment, the number of devices 3 receiving the group of operations extracted as the group of operations that requires the determination as to whether to suggest collective control is calculated as the operation cost. Thus, the second embodiment enables a comparison as to whether a collective control of the extracted group of operations to a plurality of devices 3 can make labor required to perform the group of operations lighter than that required to individually perform while changing the operated device 3.

### THIRD EMBODIMENT

Hereinafter, a third embodiment according to the present disclosure will be described with reference to the drawings. In the third embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

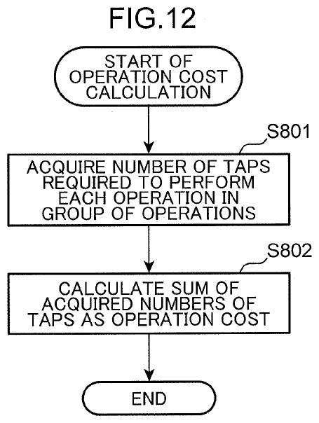

In the third embodiment, the calculation part 123 calculates the number of contacts by an operator with the operation screen of the operation terminal 2 from start to end of the group of operations extracted in Step S402 as the operation cost. Specifically, the operation screen of the operation terminal 2 is operated with a soft key displayed on the operation screen. FIG. 12 is a flowchart of an exemplary operation cost calculation in the third embodiment of the present disclosure. Each step shown in FIG. 12 will be described below.

### Step S801

The calculation part 123 acquires the number of taps required for each operation that is included in the group of operations extracted in Step S402 and performed with the operation terminal 2. The number of taps is the number of operations performed by the operator to a soft key displayed on the operation screen displayed on the display 23 of the operation terminal 2 by contact with the soft key. In other words, the number of taps is the number of contacts by the operator with the soft key displayed on the operation screen.

Specifically, the number of taps required to control a device 3 by performing an operation to the operation terminal 2 is stored in the operation information storage part 131 in association with identification information of the device 3 and the operation. In Step S801, the calculation part 123 acquires from the operation information storage part 131 the number of taps associated with identification information of: each operation that is included in the group of operations extracted in Step S402 and performed with the operation terminal 2; and a device 3 controlled for each operation. The calculation part 123 acquires the number of taps acquired from the operation information storage part 131 as the number of taps required to perform each operation that is included in the group of operations extracted in Step S402 and performed with the operation terminal 2.

The way of acquiring the number of taps in Step S801 is not limited to this. For example, the processor 22 may count the number of operations to the soft key accepted by the operation part 25 when the operation terminal 2 is operated, and include the number in operation information to be transmitted to the management server 1; and, in Step S801, the calculation part 123 may refer to the operation information stored in the operation information storage part 131 and acquire the number of taps required to perform each operation that is included in the group of operations extracted in Step S402 and performed with the operation terminal 2.

### Step S802

The calculation part 123 calculates a sum of the respective numbers of taps, acquired in Step S801, required to perform the operations that are included in the group of operations extracted in Step S402 and performed with the operation terminal 2, as the operation cost.

The calculation part 123 may calculate the number of operations by the operator to a switch of a device 3 by contact with the switch from start to end of the group of operations extracted in Step S402 as the operation cost instead of the number of contacts by the operator with the operation screen of the operation terminal 2.

In this case, in Step S801, the calculation part 123 acquires, as the number of taps, the number of contacts by the operator with a switch of a device 3 for each operation that is included in the group of operations extracted in Step S402 and performed with a switch of a device 3.

Specifically, the number of taps required to control a device 3 by performing an operation to a switch of the device 3 is stored in the operation information storage part 131 in association with identification information of the device 3 and the operation. In Step S801, the calculation part 123 acquires from the operation information storage part 131 the number of taps associated with identification information of: each operation that is included in the group of operations extracted in Step S402 and performed with a switch of a device 3; and the device 3 controlled for each operation. The calculation part 123 acquires the number of taps acquired from the operation information storage part 131 as the number of taps required to perform each operation that is included in the group of operations extracted in Step S402 and performed with a switch of a device 3.

The above is not limited to this. For example, a device 3 may count the number of operations to a switch of the device 3 when the switch is operated, and include the number in operation information to be transmitted to the management server 1; and, in Step S801, the calculation part 123 may refer to the operation information stored in the operation information storage part 131, and acquire the number of taps required to perform each operation that is included in the group of operations extracted in Step S402 and performed with a switch of a device 3.

In this example, in Step S802, the calculation part 123 calculates a sum of the respective numbers of taps, acquired in Step S801, required to perform the operations that are included in the group of operations extracted in Step S402 and performed with a switch of a device 3.

The operation cost calculated in Step S802 is used to be compared with the predetermined value in Step S404. The predetermined value in the embodiment is, e.g., a sum of respective numbers of taps required to perform operations in a group of operations indicated by suggestion information whose suggestion was accepted by the user in the past, which was calculated as the operation cost required to perform the group of operations in the generation of the suggestion information. The predetermined value is not limited to this, and may be arbitrarily determined by the user. Alternatively, the predetermined value may be the number of taps required to perform a certain operation by use of the operation terminal 2 for collective control of the group of operations to the devices 3 extracted in Step S402.

As described above, in the third embodiment, the sum of the respective numbers of taps required to perform the operations in the groups of operations extracted as the group of operations that requires the determination as to whether to suggest collective control is calculated as the operation cost. Thus, the third embodiment enables a comparison as to whether a collective control of the extracted group of operations to a plurality of devices 3 can make labor required to perform the group of operations lighter than that required to perform while transitioning between respective switches of devices 3 or soft keys.

### FOURTH EMBODIMENT

Hereinafter, a fourth embodiment according to the present disclosure will be described with reference to the drawings. In the fourth embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

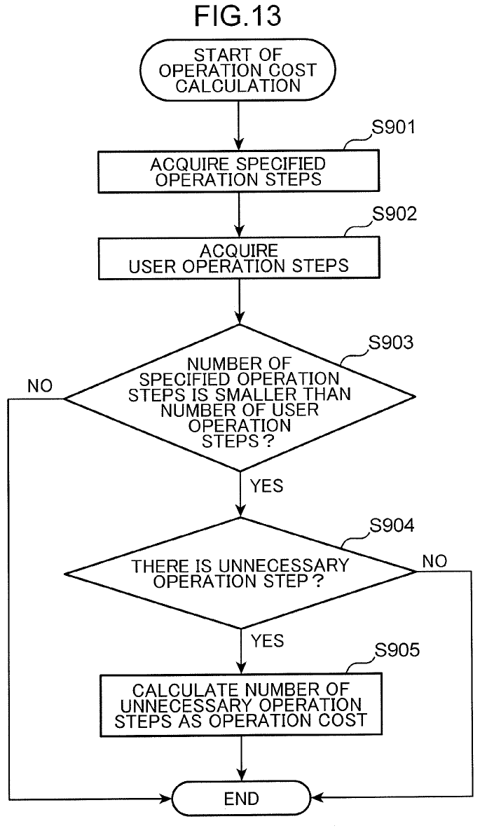

In the fourth embodiment, the calculation part 123 calculates the number of operations that are included in the group of operations extracted in Step S402 and are unnecessary in view of specifications of the devices 3 receiving the group of operations as the operation cost. FIG. 13 is a flowchart of an exemplary operation cost calculation in the fourth embodiment of the present disclosure. Each step shown in FIG. 13 will be described below.

Step S901 The calculation part 123 acquires respective specified operation steps associated with the operations in the group of operations extracted in Step S402.

The specified operation step associated with one operation refers to a group of minimum operations to a switch of a device 3 and a group of minimum operations to a soft key of the operation terminal 2 for executing the same control as the control of the device 3 for the one operation, and is determined in specifications of the device 3. The specifications of each of the devices 3 disposed in the facility 4 is stored in the operation information storage part 131 in association with the identification information of each of the devices 3. Thus, in Step S901, the calculation part 123 refers to specifications stored in the operation information storage part 131 of devices 3 controlled for the group of operations extracted in Step S402, and acquires respective specified operation steps associated with the operations in the group of operations.

Specifically, in a case where an operation in the group of operations extracted in Step S402 is an operation to a switch of a device 3, the calculation part 123 acquires a group of minimum operations to a switch of the device 3 for executing the same control as the control of the device 3 for the operation, as the specified operation step. On the other hand, in a case where an operation in the group of operations extracted in Step S402 is an operation to the operation terminal 2, the calculation part 123 acquires a group of minimum operations to a soft key of the operation terminal 2 for executing the same control as the control of the device 3 for the operation, as the specified operation step.

### Step S902

The calculation part 123 acquires respective operation steps executed by the user (hereinafter, user operation step) for the operations in the group of operations extracted in Step S402. The user operation step refers to a group of operations to a switch of a device 3 and a group of operations to a soft key of the operation terminal 2 performed by the user for each of the operations in the group of operations extracted in Step S402.

Specifically, in a case where a soft key of the operation terminal 2 is used to operate a device 3, the processor 22 includes identification information of the soft key in the operation information and transmits it to the management server 1. Similarly, in a case where a switch of a device 3 is used to operate the device 3, the device 3 includes identification information of the switch in the operation information and transmits it to the management server 1. Thus, in Step S902, the calculation part 123 can acquire the user operation step by referring to the operation information stored in the operation information storage part 131.

### Step S903

The calculation part 123 compares the number of the specified operation steps acquired in Step S901 with the number of the user operation steps acquired in Step S902.

Specifically, in Step S903, the calculation part 123 calculates a sum of the respective numbers acquired in Step S901 of the specified operation steps associated with the operations in the group of operations extracted in Step S402, as the number of the specified operation steps acquired in Step S901. Similarly, the calculation part 123 calculates a sum of the respective numbers acquired in Step S902 of the user operation steps associated with the operations in the group of operations extracted in Step S402, as the number of the user operation steps acquired in Step S902.

In a case where the number of the specified operation steps is smaller than the number of the user operation steps (YES in Step S903), the calculation part 123 executes Step S904. In a case where the number of the specified operation steps is not smaller than the number of the user operation steps (NO in Step S903), the calculation part 123 ends the operation cost calculation. In this case, the process proceeds to Step S404 in FIG. 9. In this case, it is determined that the operation cost is not larger than the predetermined value in Step S404 (NO in Step S404) because the operation cost calculation was ended without a calculation of an operation cost. Accordingly, the process shown in FIG. 9 is ended without transmission of the suggestion information indicative of the suggestion for collective control of the group of operations extracted in Step S402 to the user.

### Step S904

The calculation part 123 compares the specified operation steps acquired in Step S901 with the user operation steps acquired in Step S902 to determine whether there is an unnecessary operation step in the user operation steps acquired in Step S902.

The unnecessary operation step refers to, e.g., an operation to a switch of a device 3 or one to a soft key for cancelling a previous operation to a switch of the device 3 or a soft key. Specific examples of the unnecessary operation step include an operation to a button of “return” of a remote controller for a television, and an operation to a soft key indicative of “close” or “return” for returning an operation screen 80 displayed on the display 23 to a previous operation screen 80.

In contrast, an operation step that is not included in the unnecessary operation step refers to an operation to a switch of a device 3 and one to a soft key that the user seems to perform for a purpose, e.g., an operation of pushing channel buttons of the remote controller for the television one after another to search for a desired program.

Information on the unnecessary operation step for each of the devices 3 is stored in the memory 13. Thus, in Step S904, the calculation part 123 refers to the information on the unnecessary operation step for each of the devices 3 stored in the memory 13, and determines whether there is an unnecessary operation step in the user operation steps acquired in Step S902.

In a case where the calculation part 123 determines in Step S904 that there is an unnecessary operation step (YES in Step S904), it executes Step S905. In a case where the calculation part 123 determines in Step S904 that there is no unnecessary operation step (NO in Step S904), it ends the operation cost calculation. In this case, the process proceeds to Step S404 in FIG. 9. In this case, it is determined in Step S404 that the operation cost is not larger than the predetermined value (NO in Step S404) because the operation cost calculation is ended without a calculation of an operation cost. Accordingly, the process shown in FIG. 9 is ended without transmission of the suggestion information indicative of the suggestion for collective control of the group of operations extracted in Step S402 to the user.

Step S905 The calculation part 123 calculates the number of unnecessary operation steps recognized in Step S904 as the operation cost.

The operation cost calculated in Step S905 is used to be compared with the predetermined value in Step S404. In the embodiment, the predetermined value is, for example, arbitrarily determined by the user.

In a case where it is determined in Step S404 that the operation cost is larger than the predetermined value, the generation part 125 may include the operation cost calculated in Step S905 in generated suggestion information in Step S405; and, in Step S302 executed thereafter, the processor 22 of the operation terminal 2 may cause the display 23 to display the suggestion information received in Step S301 as shown in FIG. 8B.

FIG. 8B is another exemplary representation of the suggestion information. Specifically, the processor 22 may cause the first display field 81 to show information indicative of the number of performances of a specified unnecessary operation, which is indicated by the operation cost included in the suggestion information, instead of the frequency information included in the suggestion information.

As described above, in the fourth embodiment, the number of specified unnecessary operation steps included in the group of operations extracted as the group of operations that requires the determination as to whether to suggest collective control is calculated as the operation cost. Thus, the fourth embodiment enables identification of a specified unnecessary operation performed by the user and included in the group of operations extracted as the group of operations that requires the determination as to whether to suggest collective control, and therefore enables a determination based on the number of the identified operations as to whether to suggest collective control of the group of operations to a plurality of devices 3.

### FIFTH EMBODIMENT

Hereinafter, a fifth embodiment according to the present disclosure will be described with reference to the drawings. In the fifth embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

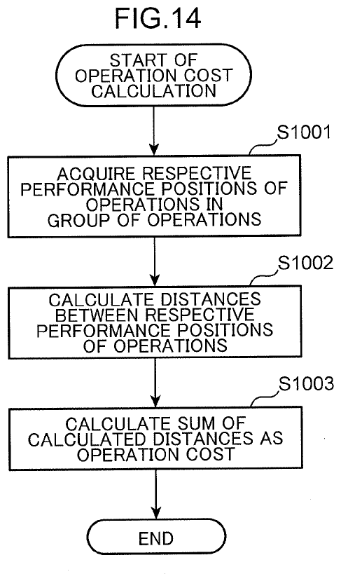

The calculation part 123 may calculate a movement distance of the user from start to end of the group of operations extracted in Step S402 as the operation cost. Specifically, in the fifth embodiment, the calculation part 123 calculates a sum of distances between respective performance positions of the operations in the group of operations extracted in Step S402 as the operation cost. FIG. 14 is a flowchart of an exemplary operation cost calculation in the fifth embodiment of the present disclosure. Each step shown in FIG. 14 will be described below.

### Step S1001

The calculation part 123 acquires a performance position of each operation in the group of operations extracted in Step S402. The performance position of each operation is a position of a switch of a device 3 or a position of the operation terminal 2 used by the user to perform each operation. Specifically, in Step S1001, the calculation part 123 refers to operation positions in the operation information stored in the operation information storage part 131, and acquires respective performance positions of the operations in the group of operations extracted in Step S402.

### Step S1002

The calculation part 123 calculates distances between respective performance positions of the operations acquired in Step S1001. Specifically, in Step S1002, the calculation part 123 refers to operation times in the operation information stored in the operation information storage part 131, and calculates each direct distance between a performance position of one operation and a performance position of an operation following the one operation in performance order of the operations by the user.

### Step S1003

The calculation part 123 calculates a sum of the distances calculated in Step S1002 as the operation cost.

The operation cost calculated in Step S1003 is used to be compared with the predetermined value in Step S404. The predetermined value in the embodiment is, e.g., a sum of distances between respective performance positions of operations in a group of operations indicated by suggestion information whose suggestion was accepted by the user in the past, which was calculated as the operation cost required to perform the group of operations in the generation of the suggestion information. The predetermined value is not limited to this, and may be arbitrarily determined by the user.

As described above, in the fifth embodiment, a sum of distances between respective performance positions of the operations in the group of operations extracted as the group of operations that requires the determination as to whether to suggest collective control is calculated as the operation cost. Thus, the fifth embodiment enables a comparison as to whether a collective control of the extracted group of operations to a plurality of devices 3 can reduce a movement distance of the user required to perform the group of operations.

### SIXTH EMBODIMENT

Hereinafter, a sixth embodiment according to the present disclosure will be described with reference to the drawings. In the sixth embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

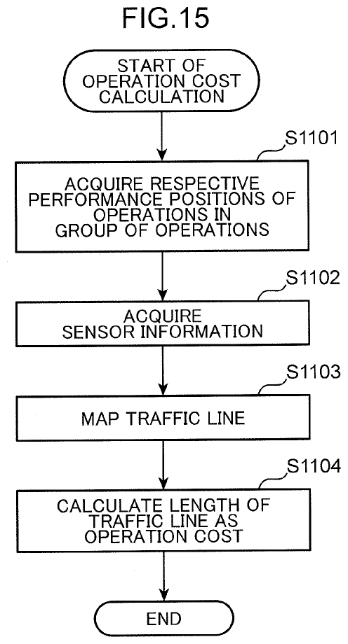

The calculation part 123 may calculate a movement distance of the user from start to end of the group of operations extracted in Step S402 as the operation cost. Specifically, in the sixth embodiment, the calculation part 123 calculates a length of a traffic line of the user from the start to end of the group of operations extracted in Step S402 as the operation cost. FIG. 15 is a flowchart of an exemplary operation cost calculation in the sixth embodiment of the present disclosure. Each step shown in FIG. 15 will be described below.

### Step S1101

The calculation part 123 acquires respective performance positions of the operations in the group of operations extracted in Step S402, similarly as in Step S1001 in the fifth embodiment.

### Step S1102

The calculation part 123 acquires sensor information concerning a period from the start to end of the group of operations extracted in Step S402. The sensor information is information on behavior of the user present in the facility 4.

Specifically, sensor information includes, e.g., a date and time of acquisition of the sensor information and a visit position of the user in the facility 4. The sensor information is acquired by a sensor having a function of communicating with the management server 1 through the network 9, e.g., a camera or a human detection sensor disposed in the facility 4. The sensor information is periodically transmitted to the management server 1 by the sensor. The acquisition part 121 acquires the sensor information received by the communication circuit 11 from the sensor, and stores the acquired sensor information in the memory 13. Thus, in Step S1102, the calculation part 123 acquires from the memory 13 sensor information concerning a period from the start to end of the group of operations extracted in Step S402.

### Step S1103

The calculation part 123 acquires a traffic line map of the user from the start to end of the group of operations extracted in Step S402 based on the respective performance positions acquired in Step S1101 of the operations in the group of operations extracted in Step S402 and the sensor information acquired in Step S1102. The traffic line map of the user is information including a chronological array of the visit positions of the user.

Specifically, in Step S1103, the calculation part 123 refers to the operation information stored in the operation information storage part 131, and acquires respective performance positions of the operations in the group of operations extracted in Step S402. Further, the calculation part 123 acquires visit positions of the user until a performance time of a next operation in time order from the sensor information acquired in Step S1102.

### Step S1104

The calculation part 123 generates a traffic line of the user from the start to end of the group of operations extracted in Step S402 by connecting chronologically arrayed positions in the traffic line map acquired in Step S1103 one after another by straight lines. The calculation part 123 calculates a length of the generated traffic line as the operation cost.

The operation cost calculated in Step S1104 is used to be compared with the predetermined value in Step S404. The predetermined value in the embodiment is, e.g., a length of a traffic line of the user from start to end of a group of operations indicated by suggestion information whose suggestion was accepted by the user in the past, which was calculated as the operation cost required to perform the group of operations in the generation of the suggestion information.

The predetermined value is not limited to this, and may be arbitrarily determined by the user.

As described above, in the sixth embodiment, the length of the traffic line of the user from the start to end of the group of operations extracted as the group of operations that requires the determination as to whether to suggest collective control is calculated as the operation cost.

In the fifth embodiment, the sum of the distances between the respective performance positions of the operations in the group of operations is calculated as the operation cost. However, in this embodiment, a visit position of the user for performing a task such as folding a futon while moving between respective performance positions of operations is taken into account. Thus, a more exact movement distance of the user from the start to end of the group of operations can be acquired; the movement distance can serve as the calculated operation cost.

Thus, the sixth embodiment enables a more accurate comparison as to whether a collective control of the extracted group of operations to a plurality of devices 3 can reduce a movement distance of the user required to perform the group of operations.

### SEVENTH EMBODIMENT

Hereinafter, a seventh embodiment according to the present disclosure will be described with reference to the drawings. In the seventh embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

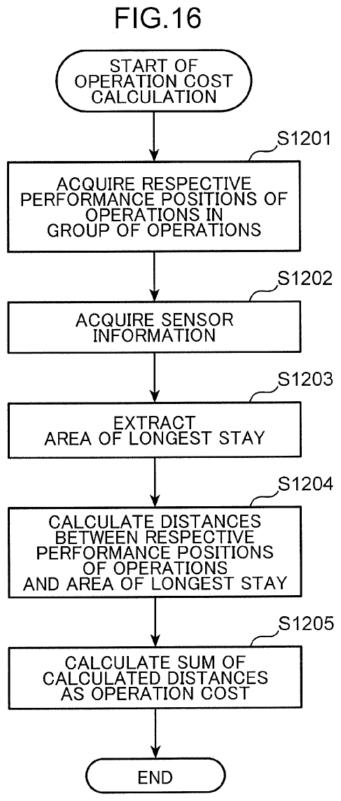

The calculation part 123 may acquire a movement distance of the user from the start to end of the group of operations extracted in Step S402 as the operation cost. Specifically, in the seventh embodiment, the calculation part 123 calculates a sum of distances between a place where the user stays in the facility 4 for the longest time and respective performance positions of the operations in the group of operations extracted in Step S402 as the operation cost. FIG. 16 is a flowchart of an exemplary operation cost calculation in the seventh embodiment of the present disclosure. Each step shown in FIG. 16 will be described below.

### Step S1201

The calculation part 123 acquires respective performance positions of the operations in the group of operations extracted in Step S402, similarly as in Step S1001 in the fifth embodiment.

### Step S1202

The calculation part 123 acquires sensor information, similarly as in Step S1102 in the sixth embodiment.

### Step S1203

The calculation part 123 extracts an area where the user stays in the facility 4 for the longest time. Specifically, the calculation part 123 refers to the layout information stored in the layout information storage part 133, and separates a division and a room in the facility 4 into a plurality of areas each having a certain size. The calculation part 123 extracts from the areas an area that has the largest number of visit positions of the user indicated by the sensor information acquired in Step S1202 as the area where the user stays in the facility 4 for the longest time. Thus, for example, an area including a position of a sofa placed in the living room is extracted as the area where the user stays in the facility 4 for the longest time.

In Step S1203, instead of extracting the area where the user stays in the facility 4 for the longest time on the basis of the layout information and the sensor information as described above, the calculation part 123 may cause the user to input information indicative of the area.

Specifically, the calculation part 123 may transmit to the operation terminal 2 information for guiding the user to input information indicative of the area of longest stay by use of the operation part 25 of the operation terminal 2; the processor 22 of the operation terminal 2 may transmit, when the user inputs information indicative of the area using the operation part 25 of the operation terminal 2 in response to this guidance, the information indicative of the area to the management server 1 through the communication circuit 21; and the calculation part 123 may extract the area from the information indicative of the area received by the communication circuit 11 from the operation terminal 2.

### Step S1204

The calculation part 123 calculates distances between respective performance positions acquired in Step S1201 of the operations in the group of operations extracted in Step S402 and the area extracted in Step S1203. Specifically, the calculation part 123 calculates a distance between a performance position acquired in Step S1201 of each of the operations in the group of operations extracted in Step S402 and a central position of the area extracted in Step S1203.

The above is not limited to this. In Step S1204, the calculation part 123 may calculate a distance between the central position of the area extracted in Step S1203 and a performance position of the first operation in the group of operations extracted in Step S402; further, in Step S1204, the calculation part 123 may calculate a distance between respective performance positions of operations acquired in Step S1201, similarly as in Step S1002 in the fifth embodiment.

In other words, in this case, the calculation of distance from the area extracted in Step S1203 is performed only for the performance position of the first operation in the group of operations extracted in Step S402. The first operation in the group of operations extracted in Step S402 can be recognized by reference to the operation information stored in the operation group information storage part 132.

### Step S1205

The calculation part 123 calculates a sum of the distances calculated in Step S1204 as the operation cost.

The operation cost calculated in Step S1205 is used to be compared with the predetermined value in Step S404. The predetermined value in the embodiment is, e.g., a sum of distances between the area where the user stays in the facility 4 for the longest time, and respective performance positions of operations in a group of operations indicated by suggestion information whose suggestion was accepted by the user in the past, which was calculated as the operation cost required to perform the group of operations in the generation of the suggestion information.

The predetermined value is not limited to this, and may be arbitrarily determined by the user. Alternatively, the predetermined value may be a distance between: a stationary or wall-embedded operation terminal 2 for performing a certain operation for collective control of the group of operations to a plurality of devices 3 extracted in Step S402; and the central position of the area where the user stays for the longest time, extracted in Step S1203.

As described above, in the seventh embodiment, a sum of movement distances of the user between: the area where the user stays in the facility 4 for the longest time; and respective performance positions of the operations in the group of operations extracted as the group of operations that requires the determination as to whether to suggest collective control is calculated as the operation cost. Therefore, the seventh embodiment enables calculation of an operation cost more adapted to behavior in daily life of the user.

Thus, the seventh embodiment enables an appropriate comparison as to whether a collective control of the extracted group of operations to a plurality of devices 3 can reduce a movement distance of the user required to perform the group of operations.

### EIGHTH Embodiment

Hereinafter, an eighth embodiment according to the present disclosure will be described with reference to the drawings. In the eighth embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

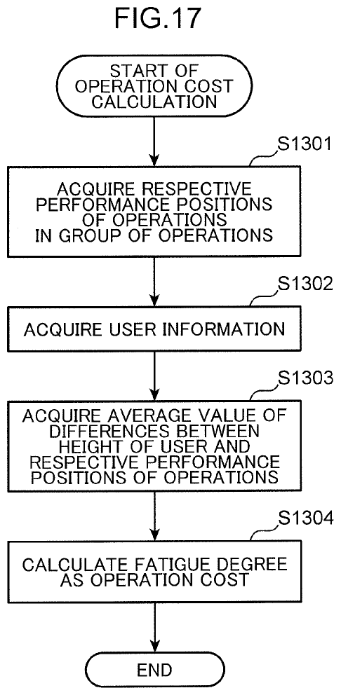

In the eighth embodiment, the calculation part 123 calculates a fatigue degree indicative of a load on a body of the user in performing the group of operations extracted in Step S402 as the operation cost. FIG. 17 is a flowchart of an exemplary operation cost calculation in the eighth embodiment of the present disclosure. Each step shown in FIG. 17 will be described below.

### Step S1301

The calculation part 123 acquires respective performance positions of the operations in the group of operations extracted in Step S402, similarly as in Step S1001 in the fifth embodiment.

### Step S1302

The calculation part 123 acquires user information. Specifically, the user information has information indicative of a physical feature of the user. The physical feature includes a height of the user.

In the eighth embodiment, the facility 4 is provided with a camera having a function of communicating with the management server 1 through the network 9. The camera periodically transmits image data indicative of a taken image of the inside of the facility 4 to the management server 1. The acquisition part 121 stores the image data received by the communication circuit 11 from the camera in the memory 13 in association with a current date and time. The calculation part 123 refers to the operation information stored in the operation information storage part 131, and acquires from the memory 13 image data associated with the date and time when the group of operations extracted in Step S402 is performed. The calculation part 123 executes known image recognition processing on the acquired image data to thereby acquire user information.

The way how the calculation part 123 acquires the user information is not limited to this. For example, a step after Step S402 of the extraction of the group of operations that requires the determination as to whether to suggest collective control may require the user to input user information by using the operation part 25 of the operation terminal 2, and the operation terminal 2 may transmit the user information to the management server 1. In this case, the acquisition part 121 stores the user information received by the communication circuit 11 from the operation terminal 2 in the memory 13, and the calculation part 123 acquires the user information from the memory 13 in Step S1302.

### Step S1303

The calculation part 123 acquires an average value of differences between the height of the user and heights from a floor surface to respective performance positions acquired in Step S1301 of the operations in the group of operations extracted in Step S402, on the basis of the user information acquired in Step S1302.

Specifically, in Step S1303, the calculation part 123 refers to the layout information stored in the layout information storage part 133, and calculates heights from the floor surface to the respective performance positions of the operations in the group of operations extracted in Step S402 on the basis of values indicative of altitudes of the performance positions of the operations. The calculation part 123 acquires the average value of the differences between the height of the user indicated by the user information and the calculated heights from the floor surface to the respective performance positions of the operations.

### Step S1304

The calculation part 123 acquires a fatigue degree associated with the average value acquired in Step S1303 of the differences between the height of the user and the heights from the floor surface to the respective performance positions of the operations. The fatigue degree indicates a degree of a load on the user in performing an operation to a device 3.

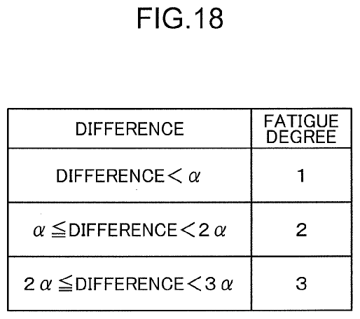

FIG. 18 is a fatigue degree table in an exemplary data configuration. Specifically, as shown in FIG. 18, the memory 13 is stored with a fatigue degree table having a fatigue degree and a difference between the height of the user and a height from the floor surface to a performance position of an operation to a device 3 in association with each other. Since the load on the body of the user in performing an operation to a device 3 is considered to be larger as a difference between the height of the user and a height from the floor surface to a performance position of the operation to the device 3 becomes larger, the fatigue degree in the fatigue degree table has a larger value as the difference becomes larger.

In Step S1304, the calculation part 123 acquires a fatigue degree associated with the average value of the differences acquired in Step S1303 from the fatigue degree table stored in the memory 13 to determine the fatigue degree as the operation cost. For example, in a case where the average value of the differences is smaller than α, the calculation part 123 acquires a fatigue degree of “1” from the fatigue degree table shown in FIG. 18 to determine the fatigue degree of “1” as the operation cost.

The operation cost calculated in Step S1304 is used to be compared with the predetermined value in Step S404. The predetermined value in the embodiment is, e.g., a fatigue degree that was calculated as the operation cost required to perform a group of operations indicated by suggestion information whose suggestion was accepted by the user in the past in the generation of the suggestion information.

The predetermined value is not limited to this, and may be arbitrarily determined by the user. Alternatively, the predetermined value may be a fatigue degree corresponding to a difference between the height of the user and a height from the floor surface to an operation terminal 2 for performing a certain operation for collective control of the group of operations to the devices 3 extracted in Step S402.

As described above, in the eighth embodiment, a fatigue degree indicative of a load on the body of the user in performing the group of operations extracted as the group of operations that requires the determination as to whether to suggest collective control is calculated as the operation cost. Thus, the eighth embodiment enables a comparison as to whether a collective control of the extracted group of operations to a plurality of devices 3 can reduce a load on the body of the user in performing the group of operations.

### NINTH EMBODIMENT

Hereinafter, a ninth embodiment according to the present disclosure will be described with reference to the drawings. In the ninth embodiment, the configuration of the management server 1, the configuration of the operation terminal 2, the data configuration of the operation information, and the data configuration of the operation group information are the same as those in the first embodiment. Therefore, the description of the same configurations as those in the first embodiment will be omitted below.

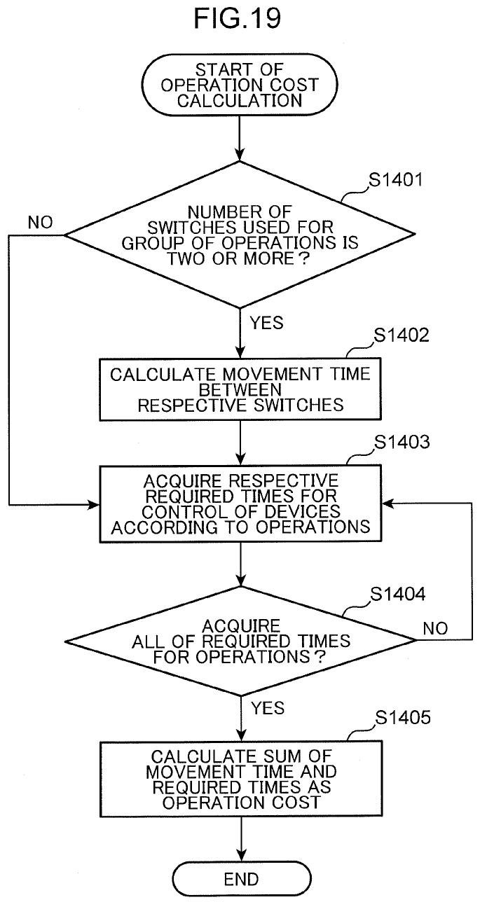

In the ninth embodiment, the calculation part 123 calculates a sum of a movement time required to move between switches used for the group of operations extracted in Step S402 and required times to control the operations in the group of operations to the devices 3 as the operation cost. FIG. 19 is a flowchart of an exemplary operation cost calculation in the ninth embodiment of the present disclosure. Each step shown in FIG. 19 will be described below.

### Step S1401

The calculation part 123 determines whether the number of switches for the devices 3 used for the group of operations extracted in Step S402 is two or more. Specifically, in a case where the operation information stored in the operation information storage part 131 and associated with the group of operations extracted in Step S402 has two or more operation information pieces indicating the symbol “*” for the switch flag and different operation positions, the calculation part 123 determines that the number of switches for the devices 3 used for the group of operations is two or more.

In a case where the operation information associated with the group of operations extracted in Step S402 has a plurality of operation information pieces indicating the symbol “*” for the switch flag and an identical operation position, the calculation part 123 counts the number of switches for devices 3 used for operations indicated by the plurality of operation information pieces as one.

In a case where the operation information associated with the group of operations extracted in Step S402 has a plurality of operation information pieces indicating the symbol “*” for the operation terminal flag and an identical operation position, one operation terminal 2 is used for operations indicated by the plurality of operation information pieces; the calculation part 123 counts the number of switches for devices 3 as one.

In a case where the calculation part 123 determines in Step 1401 that the number of switches for devices 3 is two or more (YES in Step S1401), it executes Step S1402. In a case where the calculation part 123 determines in Step S1401 that the number of switches for devices 3 is less than two (NO in Step S1401), it executes Step S1403.

### Step S1402

The calculation part 123 calculates a movement time required to move between respective switches used for the group of operations extracted in Step S402. Specifically, the calculation part 123 refers to operation times in the operation information stored in the operation information storage part 131; the calculation part 123 then calculates an elapsed time from an operation time of an operation performed with a switch of a device 3 to an operation time of a subsequent operation performed with a switch different from the switch as a movement time required to move between the respective switches, the operations being included in the group of operations extracted in Step S402.

The above is not limited to this. The calculation part 123 may refer to operation positions in the operation information stored in the operation information storage part 131; the calculation part 123 may then calculate a distance from a performance position of the operation performed with the switch of the device 3 to a performance position of the subsequent operation performed with the switch different from the switch, the operations being included in the group of operations extracted in Step S402; and the calculation part 123 may then divide the distance by a certain movement speed to thereby calculate the movement time required to move between the respective switches.

### Step S1403

The calculation part 123 acquires required times for control of the respective devices 3 according to the operations in the group of operations extracted in Step S402. Specifically, the memory 13 stores an operation to a device 3 and a required time for control of the device 3 executed according to the operation in association with each other in advance. The required time for control of a device 3 is a sum of a required time from start to end of the control and a standby time for standby before the start of the control. The standby time may be prescribed by the law of each country. The required time for the control of the device 3 maybe defined by setting the standby time to zero. In Step S1403, the calculation part 123 acquires from the memory 13 respective required times for control of devices 3 associated with operations in the group of operations extracted in Step S402.

### Step S1404

The calculation part 123 determines whether all of the respective required times for control of the devices 3 according to the operations in the group of operations extracted in Step S402 have been acquired.

In a case where the calculation part 123 determines in Step S1404 that all of the required times for the operations have been acquired (YES in Step S1404), it executes Step S1405; otherwise (NO in Step S1404), it executes Step S1403.

### Step S1405

The calculation part 123 calculates, as the operation cost, a sum of: the movement time required to move between the respective switches, acquired in Step S1402; and the respective required times for the control of the devices 3 according to the operations, acquired in Step S1403.

The operation cost calculated in Step S1405 is used to be compared with the predetermined value in Step S404. The predetermined value in the embodiment is, e.g., a value that was calculated as the operation cost required to perform a group of operations indicated by suggestion information whose suggestion was accepted by the user in the past in the generation of the suggestion information, i.e., a sum of a movement time required to move between switches used for the group of operations indicated by the suggestion information and respective required times for control of devices 3 according to the operations in the group of operations.

The predetermined value is not limited to this, and may be arbitrarily determined by the user. Alternatively, the predetermined value may be a sum of respective required times for control of devices 3 according to the group of operations extracted in Step S402. Alternatively, the predetermined value may be a time required to give control start instructions to the devices 3 collectively for starting the control of the group of operations to the devices 3 extracted in Step S402. Specifically, the time corresponds to a time required to perform an operation of transitioning a predetermined home screen displayed on the display 23 of the operation terminal 2 to an operation screen having a soft key for performing an operation of giving the control start instructions to the devices 3 collectively.

As described above, in the ninth embodiment, a sum of: a movement time required to move between switches used for the group of operations extracted as the group of operations that requires the determination as to whether to suggest collective control; and respective required times for control of devices 3 according to the operations in the group of operations is calculated as the operation cost. Thus, the ninth embodiment enables a comparison as to whether a collective control of the extracted group of operations to a plurality of devices 3 can reduce a time required to complete the control of the devices 3 while moving to perform all of the operations in the group of operations.

### TENTH EMBODIMENT

Hereinafter, a tenth embodiment according to the present disclosure will be described with reference to the drawings. In the tenth embodiment, the calculation part 123 determines whether there is at least one calculation method for output of one or more suggestion information pieces whose suggestion was accepted with a probability not lower than a certain threshold among one or more calculation methods that were used to calculate an operation cost. In a case where there is the at least one calculation method, the calculation part 123 calculates the operation cost by a calculation method indicating the highest probability among the one or more calculation methods. On the other hand, in a case where there is not the at least one calculation method, the calculation part 123 calculates the operation cost by a calculation method different from the one or more calculation methods.

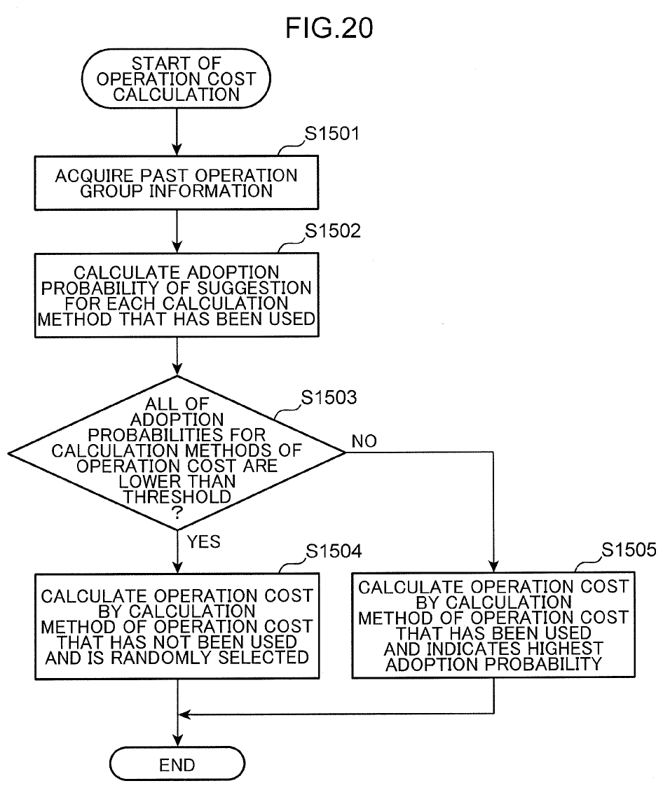

FIG. 20 is a flowchart of an exemplary operation cost calculation in the tenth embodiment of the present disclosure. Each step shown in FIG. 20 will be described below. In the description below, explanation of the same configurations as those in the first to ninth embodiments will be omitted appropriately.

### Step S1501

The calculation part 123 acquires from the operation group information storage part 132 operation group information on the group of operations that requires the determination as to whether to suggest collective control and that was extracted in Step S402 in the past. Specifically, the calculation part 123 acquires all of the operation group information stored in the operation group information storage part 132. The above is not limited to this; the calculation part 123 may acquire only the operation group information indicating an extraction date and time within a certain period (e.g., the latest one year) in the past among the operation group information stored in the operation group information storage part 132.

### Step S1502

The calculation part 123 calculates an adoption probability corresponding to each of one or more calculation methods of the operation cost that have been adopted in the past, on the basis of the operation group information acquired in Step S1501. The adoption probability corresponding to a calculation method of the operation cost indicates a probability that the user has accepted a suggestion indicated by suggestion information generated when an operation cost calculated by the calculation method is larger than the predetermined value.

Specifically, in this embodiment, the acquisition part 121 stores an operation cost and identification information (e.g., “Second Embodiment”) of a calculation method of the operation cost as the operation group information in association with each other in Step S408. In Step S1502, the calculation part 123 acquires an operation group information piece indicating the symbol “*” for the suggestion flag among the operation group information acquired in Step S1501 as a suggested operation group information piece indicative of a group of operations of which collective control has been suggested.

The calculation part 123 classifies the acquired suggested operation group information piece by calculation method of operation cost associated with the operation cost. The calculation part 123 calculates an adoption probability associated with one calculation method by dividing the number of suggested operation group information pieces indicating the symbol “*” for the acceptance flag among the suggested operation group information pieces associated with the one calculation method by the total number of the suggested operation group information pieces associated with the one calculation method.

### Step S1503

The calculation part 123 determines whether all of the respective adoption probabilities calculated in Step S1502 that are associated with the one or more calculation methods which have been adopted in the past are lower than a certain threshold.

In a case where the calculation part 123 determines in Step S1503 that all of the respective adoption probabilities calculated in Step S1502 that are associated with the one or more calculation methods which have been adopted in the past are lower than the certain threshold (YES in Step S1503), it executes Step S1504. On the other hand, in Step S1503, in a case where at least one adoption probability of the respective adoption probabilities calculated in Step S1502 that are associated with the one or more calculation methods which have been adopted is not lower than the certain threshold (NO in Step S1503), the calculation part 123 executes Step S1505.

### Step S1504

The calculation part 123 randomly selects, from the calculation methods of the operation cost described in the first to ninth embodiments, a calculation method which is not included in the one or more calculation methods that have been adopted in the past and that are indicated by the operation group information acquired in Step S1501, and calculates the operation cost by the selected calculation method.

### Step S1505

The calculation part 123 calculates the operation cost by the calculation method that corresponds to the highest adoption probability in the adoption probabilities calculated in Step S1502, among the one or more calculation methods that have been adopted in the past and that are indicated by the operation group information acquired in Step S1501.

As described above, in the tenth embodiment, in a case where all of respective adoption probabilities associated with one or more calculation methods of the operation cost that have been adopted in the past are lower than a certain threshold, the operation cost is calculated by a calculation method that has not been adopted. On the other hand, in a case where there is a calculation method for which the adoption probability is not lower than the certain threshold among the one or more calculation methods of the operation cost that have been adopted in the past, the operation cost is calculated by a calculation method indicating the highest adoption probability among the one or more calculation methods of the operation cost that have been adopted in the past. Thus, the tenth embodiment enables calculation of an operation cost by a calculation method to maximize the probability that the user accepts a suggestion.

In the present disclosure, the following modifications may be implemented.
(1) In Step S405 (FIG. 9), the generation part 125 may not generate suggestion information in a case where a group of operations extracted in Step S402 is the same group of operations as a group of operations indicated by past generated suggestion information. In this case, the procedure following Step S406 may not be executed. The configuration of the modification (1) can prevent transmissions of suggestion information on the same group of operations to the user multiple times.
(2) In Step S406 (FIG. 9), the output part 126 may refer to the operation information storage part 131, and transmit, at a time when operation information on a group of operations indicated by suggestion information generated in Step S405 (FIG. 9) is stored, the suggestion information.
The configuration of the modification (2) enables suggestion for collective control of a group of operations to a plurality of devices 3 indicated by suggestion information immediately after the user has performed the group of operations. This enables the user to more clearly understand the contents of the suggestion indicated by the suggestion information.
(3) In a case where a plurality of groups of operations is extracted in Step S402 (FIG. 9), Step S403 (FIG. 9) and Step S404 (FIG. 9) may be executed for each of the groups of operations; further, in Step S404 (FIG. 9), suggestion information may be generated for each of one or more groups of operations of which the operation cost is determined to be larger than the predetermined value; and, in Step S406, the generated suggestion information may be transmitted all together to the operation terminal 2.
In a case where there is a greater number of groups of operations of which respective operation costs are determined to be larger than the predetermined value in Step S404 (FIG. 9) than a predetermined number, in Step S405 (FIG. 9), the generation part 125 may select only the predetermined number of groups of operations in descending order of the operation costs from the greater number of groups of operations than the predetermined number, and generate suggestion information only for the selected groups of operations. This enables suggestion to the user for collective control of only the predetermined number of the groups of operations to a plurality of devices 3 that indicate larger operation costs. Thus, the probability can be increased that the user accepts a suggestion indicated by suggestion information.
(4) The acquisition part 121 may acquire from the memory 13, when acquiring operation information received from a device 3 or the operation terminal 2, sensor information associated with an operation date and an operation time included in the operation information, similarly as in Step S1102 (FIG. 15) in the sixth embodiment; the acquisition part 121 may then acquire a position where the user is present on the operation date and the operation time as a performance position of an operation to the device 3, on the basis of the sensor information; and the acquisition part 121 may then set the acquired position as an operation position for the operation information received from the device 3 or the operation terminal 2 and store the operation information in the operation information storage part 131.
(5) In the first embodiment, the predetermined value used in Step S404 (FIG. 9) may be the sum of respective required times for control of the devices 3 according to the group of operations extracted in Step S402, similarly as in the ninth embodiment.

The present disclosure, in a facility that a plurality of devices disposed, can be used for suggestion about collective control of the plurality of devices that obviates inconvenience which a user feels in individually operating the devices continuously.

1. A control method by an information processing apparatus, comprising:
acquiring operation information on a group of operations continuously performed to a plurality of devices disposed in a facility;
calculating an operation cost required to perform the group of operations indicated by the operation information;
generating, in a case that the operation cost is larger than a predetermined value, suggestion information indicative of a suggestion for performing collective control of the group of operations indicated by the operation information to the devices; and
outputting the suggestion information.

2. The control method according to claim 1, wherein
in the acquisition of the operation information, information on a group of operations continuously performed to the devices with frequency greater than predetermined frequency during a predetermined period is acquired as the operation information.

3. The control method according to claim 1, wherein the predetermined value is an operation cost that was required to perform a group of operations indicated by suggestion information whose suggestion for collective control is accepted in the past, and that calculated for output of the suggestion information.

4. The control method according to claim 1, wherein the predetermined value is arbitrarily determined by a user of the facility.

5. The control method according to claim 1, wherein the operation cost is a time required to perform the group of operations indicated by the operation information.

6. The control method according to claim 1, wherein the operation cost is the number of devices to which the group of operations indicated by the operation information is performed.

7. The control method according to claim 1, wherein
each of the devices disposed in the facility is operated with a switch of the device or an operation screen included in an operation terminal disposed in the facility, and
the operation cost is the number of contacts by an operator with the switch or the operation screen from start to end of the group of operations indicated by the operation information.

8. The control method according to claim 1, wherein the operation cost is the number of operations that are included in the group of operations indicated by the operation information and are unnecessary in view of specifications of the devices receiving the group of operations.

9. The control method according to claim 1, wherein the operation cost is a movement distance of an operator performing the group of operations from start to end of the group of operations indicated by the operation information.

10. The control method according to claim 9, wherein a sum of distances between respective performance positions of the operations in the group of operations indicated by the operation information is calculated as the movement distance.

11. The control method according to claim 9, wherein a length of a traffic line of the operator from the start to the end of the group of operations indicated by the operation information is calculated as the movement distance.

12. The control method according to claim 11, wherein the traffic line of the operator is acquired on the basis of information indicative of visit positions of the operator acquired by a sensor disposed in the facility.

13. The control method according to claim 9, wherein a sum of distances between a place where the operator stays in the facility for a longest time and respective performance positions of the operations in the group of operations indicated by the operation information is calculated as the movement distance.

14. The control method according to claim 13, wherein the place where the operator stays in the facility for the longest time is acquired on the basis of information indicative of visit positions of the operator acquired by a sensor disposed in the facility.

15. The control method according to claim 1, wherein the operation cost is a fatigue degree indicative of a load on a body of the operator in performing the group of operations indicated by the operation information.

16. The control method according to claim 15, wherein the fatigue degree is set to be larger as an average value of differences between a height of the operator and heights from a floor surface to respective performance positions of the operations in the group of operations indicated by the operation information becomes larger.

17. The control method according to claim 1, wherein
each of the devices disposed in the facility is operated with a switch of the device or a soft key displayed on an operation screen included in an operation terminal disposed in the facility, and
the operation cost is a sum of a movement time required to move between switches used for the group of operations indicated by the operation information and required times to control the operations in the group of operations to the devices.

18. The control method according to claim 1, wherein
in the calculation of the operation cost:
in a case that there is at least one calculation method that was used for output of one or more suggestion information pieces whose suggestion was accepted with a probability not lower than a certain threshold among one or more calculation methods that were used to calculate an operation cost in the past, the operation cost is calculated by a calculation method indicating the highest probability among the one or more calculation methods; and
in a case that there is not the at least one calculation method, the operation cost is calculated by a calculation method different from the one or more calculation methods.

19. An information processing apparatus comprising:
an acquisition part for acquiring operation information on a group of operations continuously performed to a plurality of devices disposed in a facility;
a calculation part for calculating an operation cost required to perform the group of operations indicated by the operation information;
a generation part for generating, in a case that the operation cost is larger than a predetermined value, suggestion information indicative of a suggestion for performing collective control of the group of operations indicated by the operation information to the devices; and
an output part for outputting the suggestion information.

20. A non-transitory computer readable storage medium storing a program causing a computer to serve as:
an acquisition part for acquiring operation information on a group of operations continuously performed to a plurality of devices disposed in a facility;
a calculation part for calculating an operation cost required to perform the group of operations indicated by the operation information;
a generation part for generating, in a case that the operation cost is larger than a predetermined value, suggestion information indicative of a suggestion for performing collective control of the group of operations indicated by the operation information to the devices; and
an output part for outputting the suggestion information.
